(19) United States
(12) Patent Application Publication
(10) Pub. No.: US 2026/0121725 A1
(43) Pub. Date: Apr. 30, 2026

(54) ADAPTIVE COMMUNICATION STATES FOR MECHANICALLY DISPLACEABLE ANTENNA PANELS

(71) Applicant: QUALCOMM Incorporated, San Diego, CA (US)

(72) Inventors: Vasanthan RAGHAVAN, West Windsor Township, NJ (US); Junyi LI, Greentown, PA (US); Yu-Chin OU, San Diego, CA (US)

(21) Appl. No.: 18/925,823

(22) Filed: Oct. 24, 2024

(51) Int. Cl. H04B 7/06; H04B 17/354; H04L 5/00

(52) U.S. Cl. CPC H04B 7/0691; H04B 17/354; H04L 5/0091

(57) ABSTRACT

In some implementations, a user equipment (UE) may transmit communication state information for multiple antenna panels of the UE, wherein the multiple antenna panels are mechanically displaceable relative to each other, and wherein the communication state information is based on relative mechanical displacements between the multiple antenna panels. The UE may communicate, via at least one antenna panel of the multiple antenna panels, one or more signals in accordance with the communication state information.

### FIELD OF THE DISCLOSURE

Aspects of the present disclosure generally relate to wireless communication and specifically relate to techniques, apparatuses, and methods associated with adaptive communication states for mechanically displaceable antenna panels.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to cause the UE to transmit communication state information for multiple antenna panels of the UE, wherein the multiple antenna panels are mechanically displaceable relative to each other, and wherein the communication state information is based on relative mechanical displacements between the multiple antenna panels. The one or more processors may be configured to cause the UE to communicate, via at least one antenna panel of the multiple antenna panels, one or more signals in accordance with the communication state information.

Some aspects described herein relate to a method of wireless communication performed by a UE. The method may include transmitting communication state information for multiple antenna panels of the UE, wherein the multiple antenna panels are mechanically displaceable relative to each other, and wherein the communication state information is based on relative mechanical displacements between the multiple antenna panels. The method may include communicating, via at least one antenna panel of the multiple antenna panels, one or more signals in accordance with the communication state information.

Some aspects described herein relate to a non-transitory computer-readable medium that stores a set of instructions for wireless communication by a UE. The set of instructions, when executed by one or more processors of the UE, may cause the UE to transmit communication state information for multiple antenna panels of the UE, wherein the multiple antenna panels are mechanically displaceable relative to each other, and wherein the communication state information is based on relative mechanical displacements between the multiple antenna panels. The set of instructions, when executed by one or more processors of the UE, may cause the UE to communicate, via at least one antenna panel of the multiple antenna panels, one or more signals in accordance with the communication state information.

Some aspects described herein relate to an apparatus for wireless communication. The apparatus may include means for transmitting communication state information for multiple antenna panels of the apparatus, wherein the multiple antenna panels are mechanically displaceable relative to each other, and wherein the communication state information is based on relative mechanical displacements between the multiple antenna panels. The apparatus may include means for communicating, via at least one antenna panel of the multiple antenna panels, one or more signals in accordance with the communication state information.

Some aspects described herein relate to a network node for wireless communication. The network node may include one or more memories and one or more processors coupled to the one or more memories. The one or more processors may be configured to cause the network node to receive communication state information for multiple antenna panels of a UE, wherein the multiple antenna panels are mechanically displaceable relative to each other, and wherein the communication state information is based on relative mechanical displacements between the multiple antenna panels. The one or more processors may be configured to cause the network node to communicate, for the UE, one or more signals in accordance with the communication state information.

Some aspects described herein relate to a method of wireless communication performed by a network node. The method may include receiving communication state information for multiple antenna panels of a UE, wherein the multiple antenna panels are mechanically displaceable relative to each other, and wherein the communication state information is based on relative mechanical displacements between the multiple antenna panels. The method may include communicating, for the UE, one or more signals in accordance with the communication state information.

Some aspects described herein relate to a non-transitory computer-readable medium that stores a set of instructions for wireless communication by a network node. The set of instructions, when executed by one or more processors of the network node, may cause the network node to receive communication state information for multiple antenna panels of a UE, wherein the multiple antenna panels are mechanically displaceable relative to each other, and wherein the communication state information is based on relative mechanical displacements between the multiple antenna panels. The set of instructions, when executed by one or more processors of the network node, may cause the network node to communicate, for the UE, one or more signals in accordance with the communication state information.

Some aspects described herein relate to an apparatus for wireless communication. The apparatus may include means for receiving communication state information for multiple antenna panels of a UE, wherein the multiple antenna panels are mechanically displaceable relative to each other, and wherein the communication state information is based on relative mechanical displacements between the multiple antenna panels. The apparatus may include means for communicating, for the UE, one or more signals in accordance with the communication state information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a device, in accordance with the present disclosure.

FIG. 4 is a diagram illustrating an example of a device including a mechanically displaceable antenna panel, in accordance with the present disclosure.

FIG. 5 is a diagram of an example associated with adaptive communication states for mechanically displaceable antenna panels, in accordance with the present disclosure.

FIG. 6 is a diagram of an example associated with adaptive communication states for antenna panels.

FIG. 7 is a diagram illustrating an example of various antenna placement configurations.

FIG. 8 is a diagram illustrating an example process performed, for example, at a user equipment (UE) or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Lower complexity devices, such as customer premises equipment (CPEs), machine-type communication (MTC) user equipments (UEs), reduced capability (RedCap) UEs, and/or Internet of Things (IoT) UEs, among other examples, may be utilized in wireless communication systems to support cost-sensitive deployments, enhance energy efficiency, and/or reduce power consumption, among other examples. These devices may be used to support widespread IoT applications and scenarios associated with large-scale, low-cost, and low-power device connectivity, such as industrial automation, smart cities, and/or home automation systems, among other examples. In some examples, such devices may use large antenna arrays (e.g., 8x8 arrays, 16x8 arrays, and/or 16x16 arrays) to ensure wide coverage and high quality of signal reception and transmission. However, the large antenna panels (also referred to as antenna arrays) can increase complexity and/or cost of these devices. Therefore, some lower complexity devices, such as CPEs, may use smaller antenna arrays (e.g., 4x4 antenna arrays) to reduce system costs, power consumption, and/or associated thermal overhead, among other examples. The devices with smaller antenna arrays may use one or more mechanisms (such as Cassegrain reflectors along with a mechanical displacement apparatus configured to displace, rotate, tilt, or otherwise move an antenna array) to maintain or enhance effective isotropic radiated power (EIRP) and array gain of signal(s) transmitted or received via the antenna array(s). For example, a UE may include multiple antenna panels that are mechanically displaceable (e.g., moveable or adjustable) relative to each other. The antenna panel(s) may be displaceable via one or more mechanical apparatuses (e.g., one or more motors or other apparatuses).

For example, two or more antenna panels of a UE (e.g., a CPE or another type of UE) may be mechanically displaced relative to each other to enable coherent communication, via the two or more antenna panels, with a single device (e.g., a single network node or another UE). For example, the two or more antenna panels of a UE may be mechanically displaced to e co-locate of the two or more antenna panels. In other situations, the two or more antenna panels may be mechanically displaced relative to each other to enable communication with multiple devices (e.g., multiple network nodes or UEs). For example, the two or more antenna panels may be mechanically displaced relative to each other to introduce separation (e.g., angular separation and/or linear separation) between the two or more antenna panels to enable the UE to communicate with a first device via a first one or more antenna panels and to communicate with a second device via a second one or more antenna panels.

In some examples, a UE may operate an antenna panel in accordance with a communication state. For example, a communication state may be a transmitting state (e.g., in which the antenna panel is configured to transmit signals), a receiving state (e.g., in which the antenna panel is configured to receive signals), or an inactive state or off state (e.g., in which the antenna panel is not configured to transmit or receive signals). However, because the antenna panels of the UE may be mechanically displaceable, some communication states and positions or orientations of antenna panels may result in degraded performance. For example, a first antenna panel may be operating in a transmitting state and a second antenna panel may be operating in a receiving state. In some positions or orientations, operation of the first antenna panel may cause interference or degraded performance for the second antenna panel (e.g., caused by signal leakage or cross talk). As another example, the first antenna panel and the second antenna panel may be configured to transmit or receive signals in a coherent manner (e.g., to or from a single node or device). In some positions or orientations, the performance of the coherent transmission or reception may be degraded (e.g., if the antenna panels are positioned too far apart or are oriented in different spatial directions). Therefore, the UE being capable of adaptively switching communication states of antenna panels for antennal panels that are mechanically displaceable (or adjustable) relative to each other introduces a risk of degraded communication performance.

Additionally, due to the inherent slowness of mechanical movements used to adjust antenna panel positions, disruptions to ongoing communications can occur which can impact signal quality and service continuity. For example, the time scale for mechanically controlled movements of antenna panels (e.g., in terms of seconds) is relatively slow compared to the time scale of signal processing in a wireless communication network (e.g., in terms of milliseconds or microseconds). These delays associated with mechanical movements of antenna panel(s) can disrupt communications (e.g., because the UE may not be configured to communicate via an antenna panel while the antenna panel is being mechanically displaced or moved) and reduce the responsiveness of the UE to changing conditions.

Further, a network node (or other device) may not obtain or have access to information indicating the mechanical displacement capabilities or adaptive communication state capabilities of the UE. Therefore, the network node may attempt to communicate with the UE in a manner that is not suitable for current positions or orientations of antenna panels of the UE and/or is not suitable for current communication states of respective antenna panels of the UE. This may result in degraded communication performance for signals communicated between the UE and the network node. As another example, the network node may assume that the UE is unable to dynamically adapt or switch communication states of one or more antenna panels and/or is unable to mechanically displace antenna panels relative to each other. As a result, the network node may configure the UE to communicate in a manner that does not enable the UE to realize the improved communication performance that is achievable via mechanically displacing antenna panels and/or adaptively switching communication states of respective antenna panels. Additionally, because the network node may not obtain or have access to information indicating the mechanical displacement capabilities or adaptive communication state capabilities of the UE, the network node may not coordinate communication parameters with the UE for different communication states and/or positions or orientations of antenna panels of the UE. Without this coordination, the UE may be unable to accurately align communication directions (e.g., beams) in a spatial direction toward the network node, leading to suboptimal signal quality and/or increased interference, among other examples. This lack of coordination can degrade communication performance and reduce data throughput.

Various aspects relate generally to communication states for mechanically displaceable antenna panels. Some aspects more specifically relate to enabling a UE with mechanically displaceable antenna panels for switching between communication states for respective antenna panels. In some aspects, the UE may transmit, and a network node may receive, communication state information for multiple antenna panels that are mechanically adjustable (e.g., displaceable) relative to each other. The communication state information may be based on, or otherwise associated with, the relative mechanical positions of the multiple antenna panels. The UE and network node may communicate one or more signals in accordance with the communication state information. The communication state(s) may be adaptive in that the UE may switch communication states for a given antenna panel over time (e.g., based on, in response to, or otherwise associated with, one or more factors or conditions).

In some aspects, the communication state information may include an indication of a capability to adaptively switch between different communication states. The communication states may include a transmitting state, a receiving state, an inactive state, a half-duplex state, or a full-duplex state, among other examples. The capability of the UE to adaptively switch between different communication states may be based on the relative mechanical displacements of the multiple antenna panels. In some aspects, the UE may measure signal leakage between antenna panels to determine antenna panel placement configurations for different communication states, allowing for minimal interference and maximal signal integrity. The UE may adjust, displace or adjust a position or orientation of one or more antenna panels to enable a given communication state. In such examples, the UE may transmit updated communication state information indicative of the communication state(s) that the UE is capable of communicating in with the current position or orientation of the antenna panels of the UE. For example, the UE may transmit updated communication state information indicating a modification to one or more communication states indicated by the communication state information in association with one or more changes in the relative mechanical displacements.

In some aspects, the network node may transmit, and the UE may receive, assistance information associated with facilitating communication via the multiple antenna panels. The information (e.g., assistance information) may be associated with the communication state information. For example, the information may include an indication to activate one or more transmission configuration indicator (TCI) states, a configuration of one or more reference signals associated with beam configurations for coherent transmission or reception, and/or an indication of a placement for one or more antenna panels of the multiple antenna panels, among other examples.

Particular aspects of the subject matter described in this disclosure can be implemented to realize one or more of the following advantages. By the UE transmitting the communication state information, the described techniques can be used to coordinate communicate states and/or positions or orientations of respective antenna panels of the UE with a network node (or another device that the UE is configured to communicate with). This enables the UE to optimize antenna placement configurations (e.g., optimizing a placement or orientation for a given communication state) in a coordinated manner with the network node, which enhances spectral efficiency and/or reduces interference, among other examples while also reducing the risk of the network node attempting to communicate with the UE in a manner that is not suitable for a current antenna placement configuration. As used herein, “antenna placement configuration” refers to a position and/or orientation of one or more antenna panels among multiple antenna panels that are mechanically displaceable. By the UE transmitting the communication state information, the UE may improve communication performance (e.g., by optimizing antenna placement configurations (e.g., position(s) and/or orientation(s)) for antennal panels of the UE) in a coordinated manner with the network node.

In some aspects, by the UE transmitting updated communication state information, the UE may improve the likelihood of optimal communication performance by informing the network node of the current state of the UE with respect to the mechanical displacements of antenna panels and/or available or possible communicate states. The updated communication state information enables the UE and/or the network node to make improved determinations associated with managing interference, performing beamforming, and/or allocating network resources, among other examples, resulting in improved communication performance and/or overall network efficiency.

In some aspects, by the network node transmitting assistance information associated with facilitating communication via multiple antenna panels, the UE and the network node may perform coordination to enable the UE to perform beamforming and/or set one or more communication parameters based on network instructions, thereby improving signal quality and reducing interference. Additionally, the information from the network node may enable the UE to implement one or more communication techniques for various communication states and/or positions or orientations of antenna panels, such as coherent beamforming and dynamic communication state switching, thereby enhancing overall communication performance and reliability. For example, by the UE using the information from the network node (e.g., by the UE performing beamforming or applying one or more TCI states), a performance of the UE in a given communication state or a given position or orientation of the antenna panels of the UE may be improved. In some aspects, by enabling the UE to place one or more antenna panels in an inactive state when not transmitting or receiving signals in a coordinated manner with the network node, the UE may conserve energy or power resources while reducing the likelihood of the network node attempting to communicate with the UE via an antenna panel that is in the inactive state.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

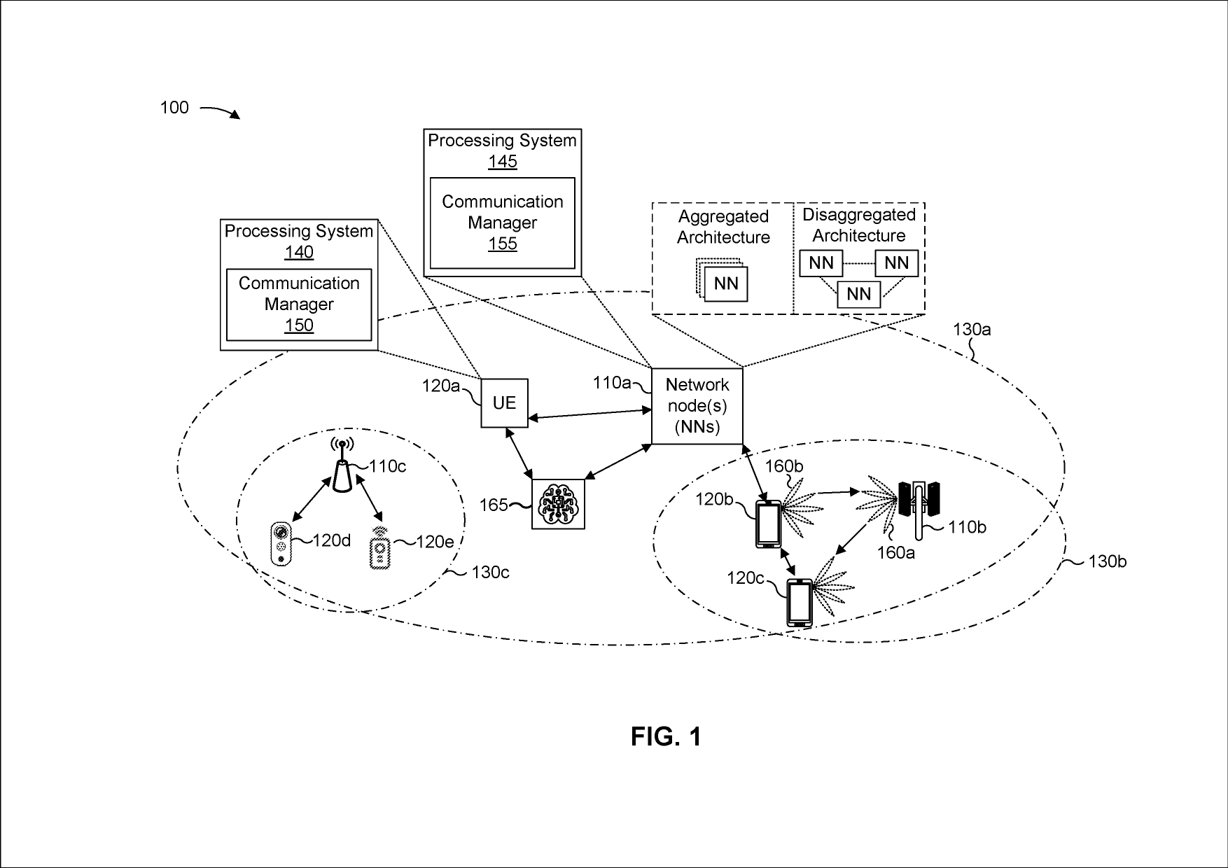

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, a UE 120d, and a UE 120e. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

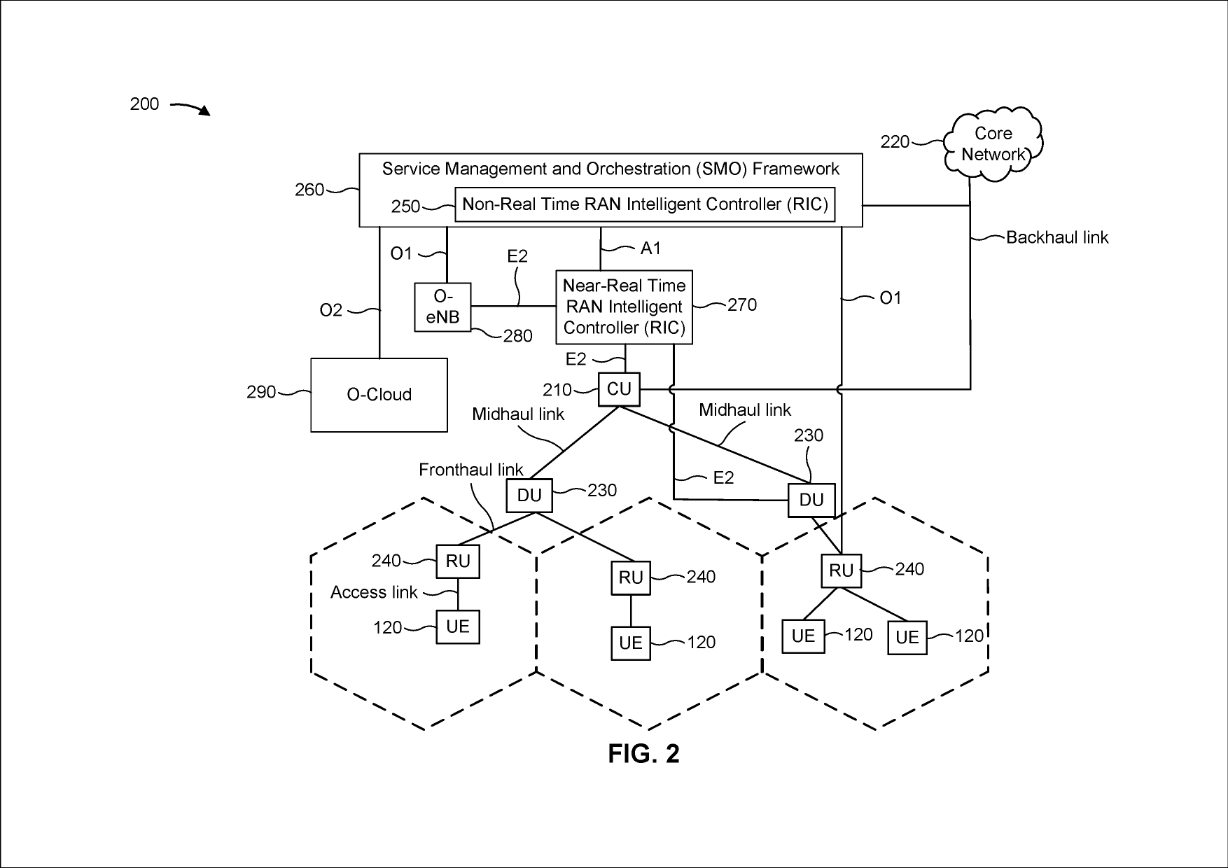

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

Some UEs 120 may be considered MTC UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs.” For example, the UE 120d may be an MTC UE, and/or the UE 120e may be an MTC UE. An MTC UE may be, may include, or may be included in or coupled with a robot, an uncrewed aerial vehicle, a remote device, a sensor, a meter, a monitor, and/or a location tag. Some UEs 120 may be considered IoT devices. Some such UEs 120 may be implemented as NB-IoT (narrowband IoT) devices, such as the UE 120d and/or the UE 120e. An IoT or NB-IoT device may be, may include, or may be included in or coupled with an industrial machine, an appliance, a refrigerator, a doorbell camera device, a home automation device, and/or a light fixture, among other examples. Some UEs 120, such as the UE 120e and/or the UE 120e, may be considered CPEs, which may include telecommunications devices that are installed at a customer location (such as a home or office) to enable access to a service provider’s network (such as included in or in communication with the wireless communication network 100). In some examples, an MTC UE, an IoT device, and/or a CPE (such as the UE 120e and/or the UE 120e) may include one or more mechanically displaceable (e.g., moveable) antenna panels or antenna elements. As shown in FIG. 1, the UEs (e.g., the UE 120e and/or the UE 120e) may communicate with the network node 110c within the cell 130c. The cell 130c may provide a coverage area for an area in which the UE(s) are located, such as a factory, an indoor area, and/or a building, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a TCI state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in the full-duplex mode, network nodes 110 and/or UEs 120 may generally increase the capacity of the network and the radio access link. In some examples, full-duplex operation may involve frequency division duplexing, in which downlink transmissions of the network node 110b are performed in a first frequency band or on a first component carrier and uplink transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may transmit communication state information for multiple antenna panels of the UE 120, wherein the multiple antenna panels are mechanically displaceable relative to each other, and wherein the communication state information is based on relative mechanical displacements between the multiple antenna panels; and communicate, via at least one antenna panel of the multiple antenna panels, one or more signals in accordance with the communication state information. Additionally, or alternatively, the communication manager 150 may perform one or more other operations described herein.

In some aspects, the network node 110 may include a communication manager 155. As described in more detail elsewhere herein, the communication manager 155 may receive communication state information for multiple antenna panels of a UE, wherein the multiple antenna panels are mechanically displaceable, and wherein the communication state information is based on relative mechanical displacements between the multiple antenna panels; and communicate, for the UE, one or more signals in accordance with the communication state information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

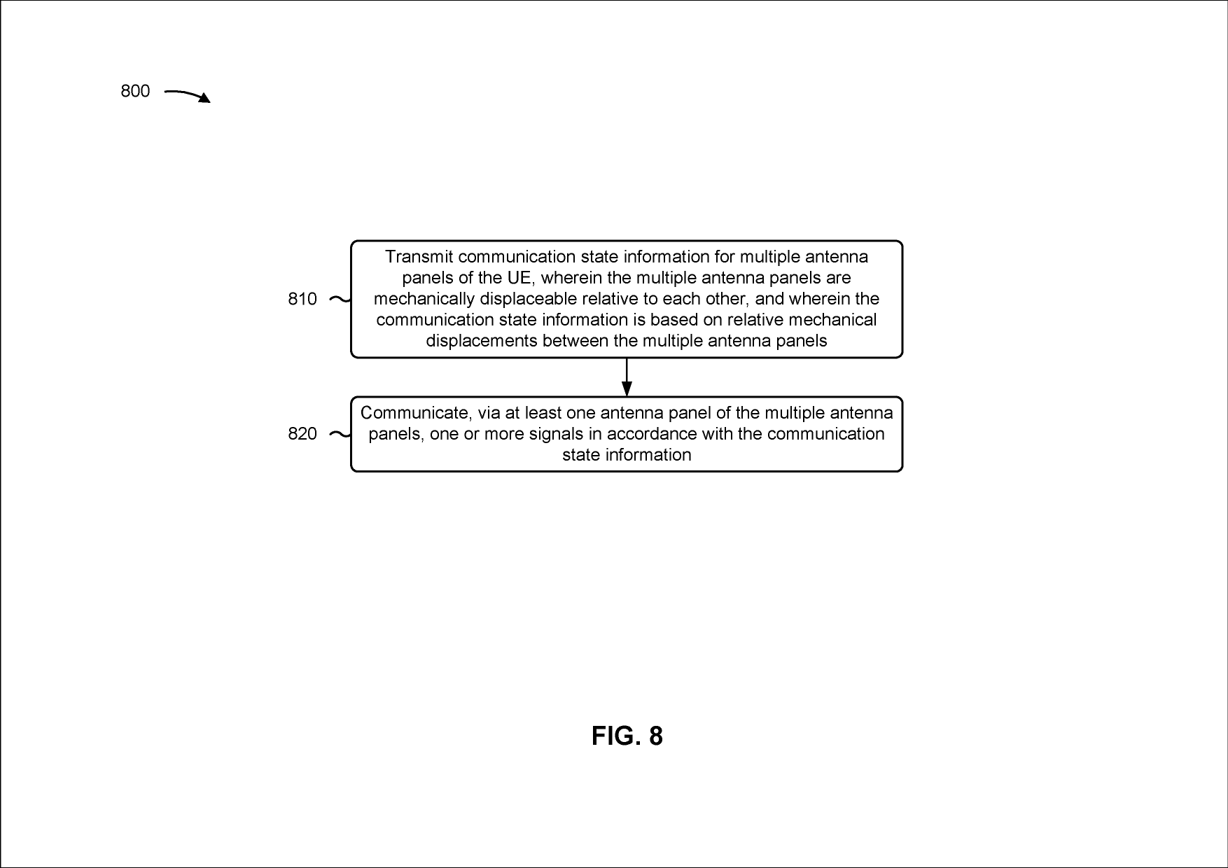

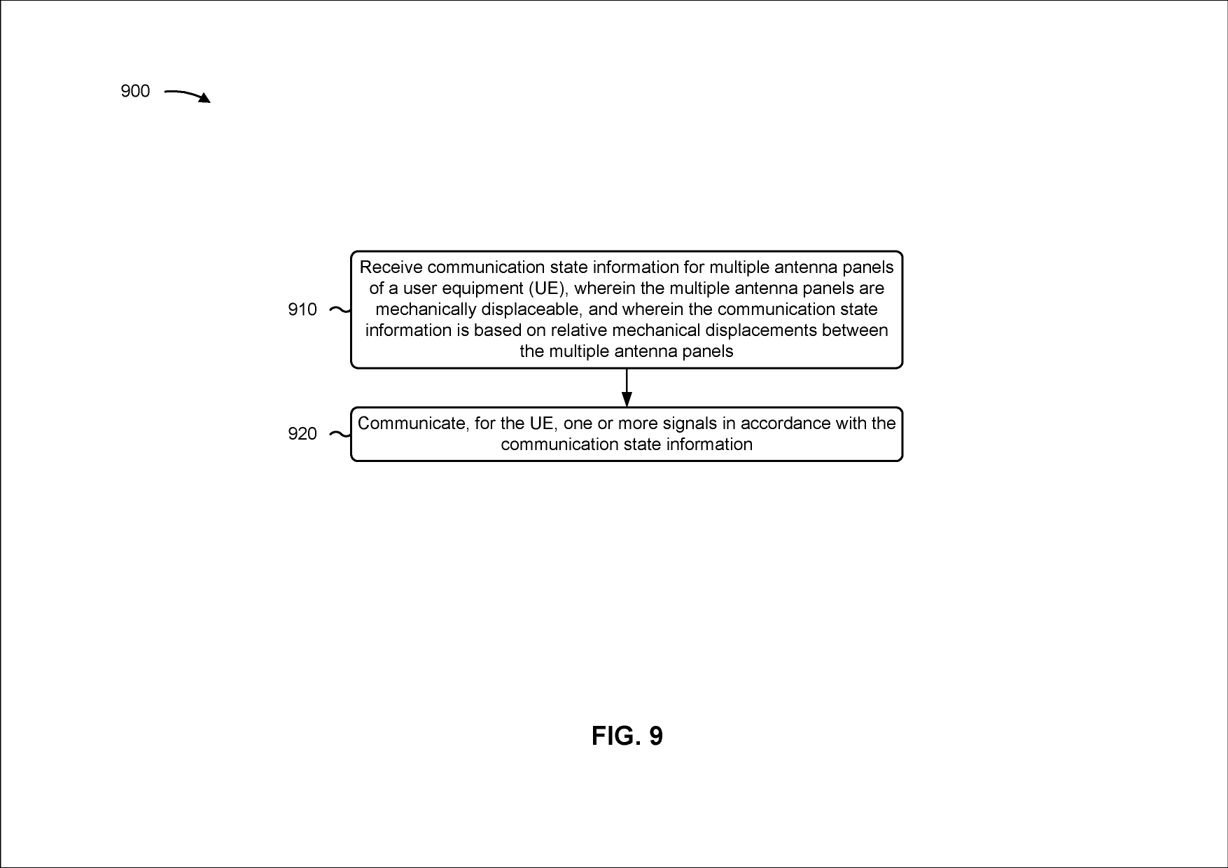

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with adaptive communication states for mechanically displaceable antenna panels, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

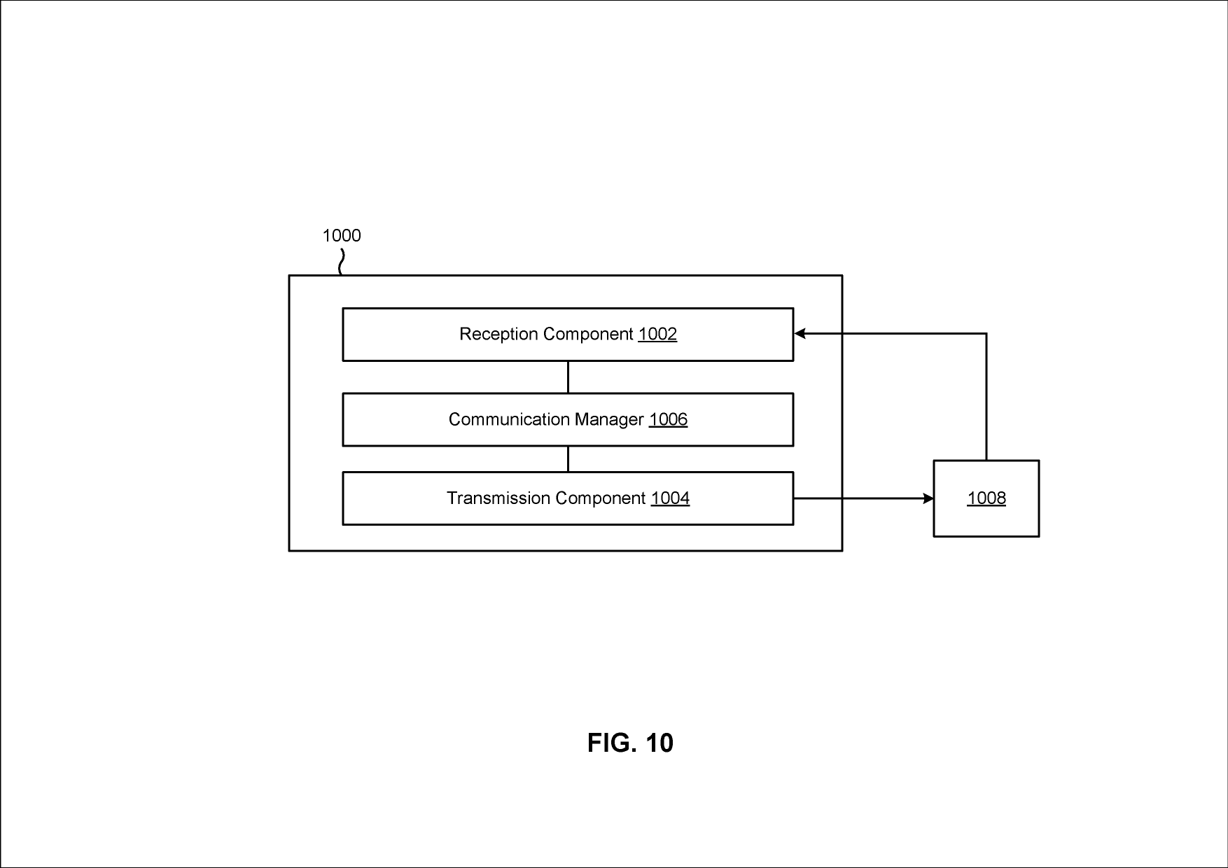

In some aspects, the UE 120 includes means for transmitting communication state information for multiple antenna panels of the UE, wherein the multiple antenna panels are mechanically displaceable relative to each other, and wherein the communication state information is based on relative mechanical displacements between the multiple antenna panels; and/or means for communicating, via at least one antenna panel of the multiple antenna panels, one or more signals in accordance with the communication state information. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10) and/or a transmission component (for example, transmission component 1004 depicted and described in connection with FIG. 10), among other examples.

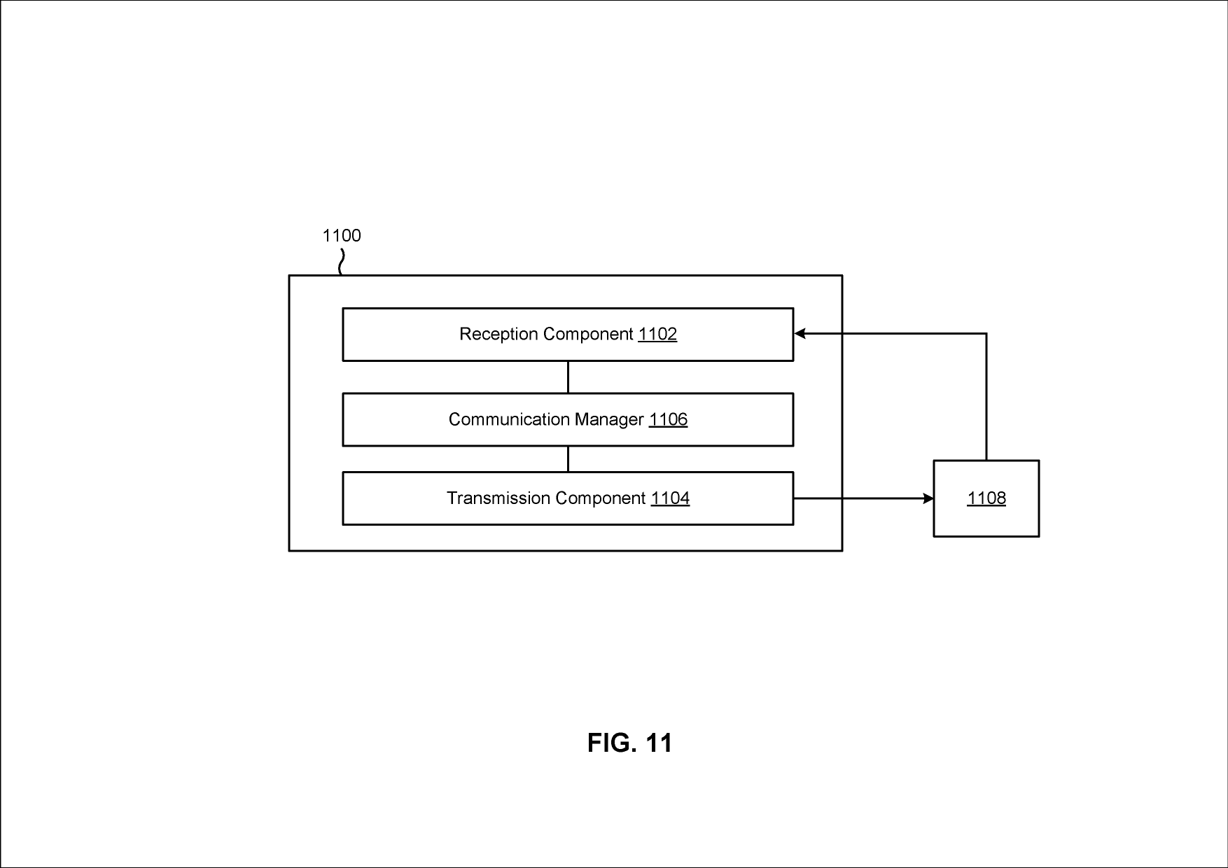

In some aspects, the network node 110 includes means for receiving communication state information for multiple antenna panels of a UE, wherein the multiple antenna panels are mechanically displaceable, and wherein the communication state information is based on relative mechanical displacements between the multiple antenna panels; and/or means for communicating, for the UE, one or more signals in accordance with the communication state information. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

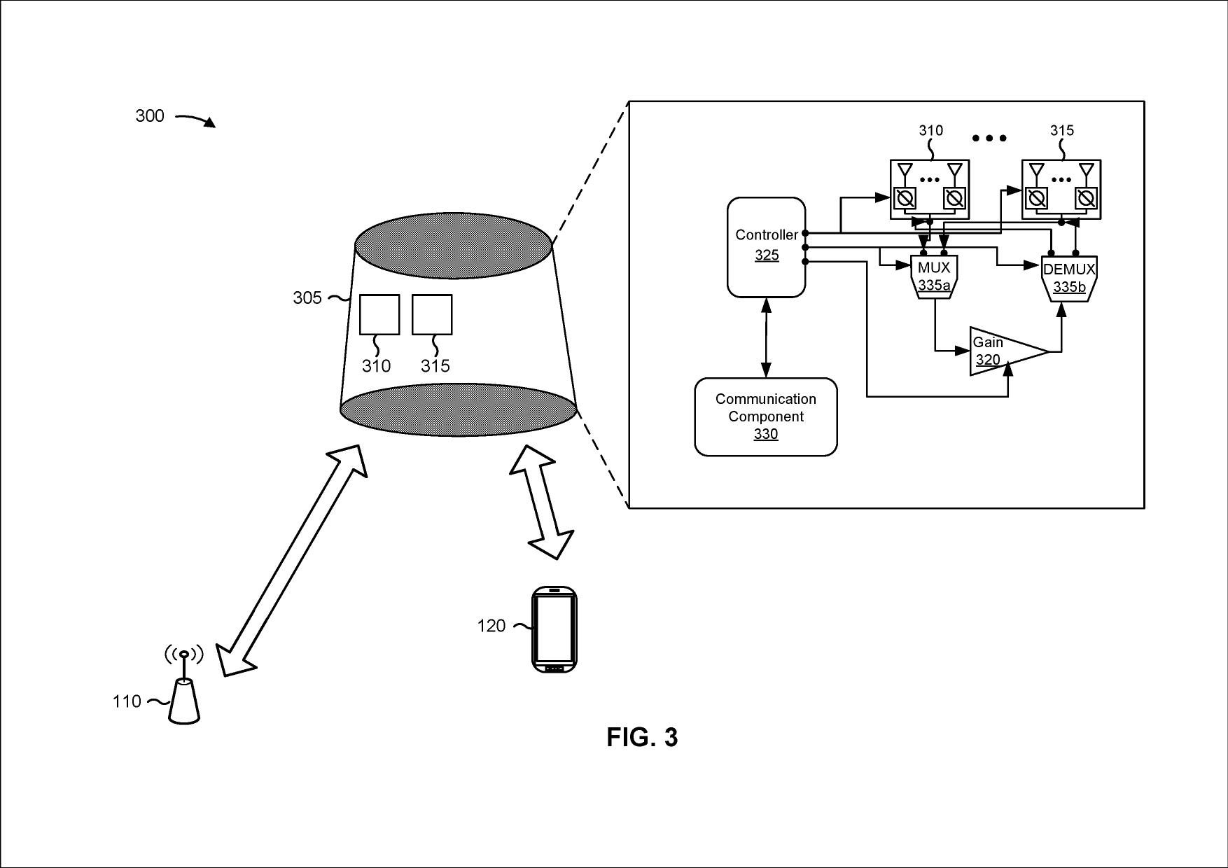

FIG. 3 is a diagram illustrating an example 300 of a device, in accordance with the present disclosure. The example 300 includes the UE 305 (e.g., that may be an example of a CPE or the UE 120e) and a network node 110 and UE 120, both connected to the UE 305 via a wireless communication link. The UE 305 may include telecommunications and/or information technology equipment that operates at a customer premises or physical location of a user. In some examples, the UE 305 may be configured to communicate via mmW frequency bands. The UE 305 may include a set of one or more antenna arrays or antenna panels including an antenna array. For example, the UE 305 in the example 300 include a first antenna panel 310 and a second antenna panel 315. The UE 305 may include one or more antenna panels in addition to antenna panels 310 and 315, a gain component 320, a controller 325, a communication component 330, and a multiplexer (MUX) and/or demultiplexer (DEMUX) (MUX/DEMUX) 335 (e.g., including a MUX 335a and a DEMUX 335b).

The antenna panels 310 and/or 315 may include multiple antenna elements capable of being configured for beamforming. In some examples, the antenna panel 310 and/or the antenna panel 315 may be a fixed receive antenna array capable of only receiving communications while not transmitting communications. In some examples, the antenna panel 310 and/or the antenna panel 315 may be a fixed transmit antenna array capable of only transmitting communications while not receiving communications. In some examples, the antenna panel 310 and/or the antenna panel 315 may be capable of being configured to act as a receive antenna array and/or a transmit antenna array, and/or may be configured for full duplex communications. The antenna panel 310 and/or the antenna panel 315 may be capable of communicating signals using mmW frequency bands.

The gain component 320 includes a component capable of amplifying an input signal and outputting an amplified signal. For example, the gain component 320 may include a power amplifier and/or a variable gain component. In some examples, the gain component 320 may have variable gain control. The gain component 320 may connect to an receive antenna array and a transmit antenna array such that a millimeter wave signal, received via the receive antenna array, can be amplified by the gain component 320 and output to the transmit antenna array for transmission. In some examples, the level of amplification of the gain component 320 may be controlled by the controller 325.

The controller 325 includes a component capable of controlling one or more other components of the UE 305. For example, the controller 325 may include a controller, a microcontroller, and/or a processor. The controller 325 may be an example of, or may be included in, a processing system of the UE 305, such as the processing system 140. In some examples, the controller 325 may control the gain component 320 by controlling a level of amplification or gain applied by the gain component 320 to an input signal. Additionally, or alternatively, the controller 325 may control the antenna panel 310 and/or the antenna panel 315 by configuring a beamforming configuration for the antenna panel 310 and/or the antenna panel 315 (for example, one or more phase values, one or more phase offsets, one or more power parameters, one or more beamforming parameters, a transmit beamforming configuration, and/or an receive beamforming configuration). Additionally, or alternative, the controller 325 may control the antenna panel 310 and/or the antenna panel 315 by configuring whether the antenna panel 310 and/or the antenna panel 315 acts as an receive antenna array and/or a transmit antenna array (for example, by configuring interaction and/or connections between the antenna panel 310 and/or the antenna panel 315 and a MUX/DEMUX 335). Additionally, or alternatively, the controller 325 may power on or power off one or more components of UE 305. In some examples, the controller 325 may control a timing of one or more of the above configurations.

The communication component 330 may include a component capable of wirelessly communicating with the network node 110 or another network node using a wireless technology other than millimeter wave (for example, via a control interface). For example, the communication component 330 may communicate with the network node 110 using a personal area network (PAN) technology (for example, Bluetooth or Bluetooth Low Energy (BLE)), a 4G or LTE radio access technology, a narrowband Internet of Things (NB-IoT) technology, a sub-6 GHz technology, and/or a visible light communication technology, among other examples. In some examples, the communication component 330 may use a lower frequency communication technology, and the antenna panel 310 and/or the antenna panel 315 may use a higher frequency communication technology (for example, millimeter wave). In some examples, the antenna panel 310 and/or the antenna panel 315 may be used to transfer data between the UE 305 and the network node 110, and the communication component 330 may be used to transfer control information between the UE 305 and the network node 110 (for example, a report, a configuration, and/or instructions to power on or power off one or more components).

The MUX/DEMUX 335 may be used to multiplex and/or demultiplex communications received from and/or transmitted to an antenna array (e.g., an antenna array of the antenna panel 310 and/or an antenna array of the antenna panel 315). For example, the MUX/DEMUX 335 may be used to switch a receive antenna array to a transmit antenna array. In some examples, one or more of the antenna panel 310 and/or the antenna panel 315, the gain component 320, the controller 325, the communication component 330, and/or the MUX/DEMUX 335 may perform one or more techniques associated with UE calibration of mmW devices for mechanical alignments, as described in more detail elsewhere herein.

Because millimeter wave communications have a higher frequency and shorter wavelength than other types of radio waves used for communications (for example, sub-6 GHz communications), millimeter wave communications may have shorter propagation distances and may be more easily blocked by obstructions than other types of radio waves. For example, a wireless communication that uses sub-6 GHz radio waves may be capable of penetrating a wall of a building or a structure to provide coverage to an area on an opposite side of the wall from a network node 110 that communicates using the sub-6 GHz radio waves. However, a millimeter wave may not be capable of penetrating the same wall (for example, depending on a thickness of the wall and/or a material from which the wall is constructed). Some techniques and apparatuses described herein use a mmW device, such as the UE 305, to increase the coverage area of a network node 110 and/or to extend coverage to other UEs.

The UE 305 may perform directional communication by using the antenna panels 310 and/or 315 and beamforming to communicate with a network node 110 via one or more beams. For example, in example 300, the UE 305 can communicate with the network node 110 via a first beam pair and can communicate with the UE 120 via a second beam pair. A beam pair may refer to a transmit (Tx) beam used by a first device for transmission and a receive (Rx) beam used by a second device for reception of information transmitted by the first device via the Tx beam.

The network node 110 may use a beam sweeping procedure to transmit communications via multiple beams over time (for example, using time division multiplexing (TDM)). The UE 305 may receive a communication via an Rx beam of the UE 305. The UE 305 may relay each received communication via multiple Tx beams of the UE 305. As used herein, relaying a communication may refer to transmitting the received communication (for example, after amplifying the received communication) without decoding the received communication and/or without modifying information carried in the received communication. Alternatively, relaying a received communication may refer to transmitting the received communication after decoding the received communication and/or modifying information carried in the received communication. In some examples, a received communication may be relayed using a different time resource, a different frequency resource, and/or a different spatial resource (for example, a different beam) to transmit the communication as compared to a time resource, a frequency resource, and/or a spatial resource in which the communication was received. The UE 120 may receive a relayed communication. In some examples, the UE 120 may generate a communication to be transmitted to the network node 110. The UE 120 may then transmit the communication to the UE 305 for relaying to the network node 110.

The antenna panel 310 and/or the antenna panel 315 may be co-located and/or similarly located for communications with a single network node 110. The 305 may include a mechanical displacement apparatus (for example, at least one motor) that may rotate, reflect, or displace the antenna panel 310 and/or the antenna panel 315 and/or any corresponding components, such as a reflector. The mechanical displacement apparatus may separate and/or displace the antenna panel 310 and/or the antenna panel 315. In such examples, the displacement may be linear, angular, and or rotational.

Some CPEs, such as the UE 305, may include large antenna arrays (for example, 8x8 element antenna arrays, 16x8 element antenna arrays, 16x16 element antenna arrays) which may cost more than smaller antenna arrays. As demand for lower-cost implementations of CPEs increases, CPEs may implemented with smaller antenna arrays to reduce cost. Some CPEs, such as the UE 305, may include a reflector and/or a mechanical rotator corresponding to each antenna panel, such as the antenna panel 310 and/or the antenna panel 315. This may enable the UE 305 to support certain communication parameters, such as radiated power and array gain, without the use of large antenna arrays. Smaller antenna arrays supported by a reflector and/or a mechanical rotator may also support reduced power consumption, reduced thermal overhead, and reduction in overall cost of the materials to manufacture the UE 305.

Other examples of the UE 305 may differ from what is described in FIG. 3. For example, the UE 305 may include additional components, fewer components, different components, or differently arranged components than those shown in FIG. 3. Furthermore, two or more components shown in FIG. 3 may be implemented within a single component, or a single component shown in FIG. 3 may be implemented as multiple components. Additionally, or alternatively, a set of components (for example, one or more components) of the UE 305 may perform one or more functions described as being performed by another set of components of UE 305.

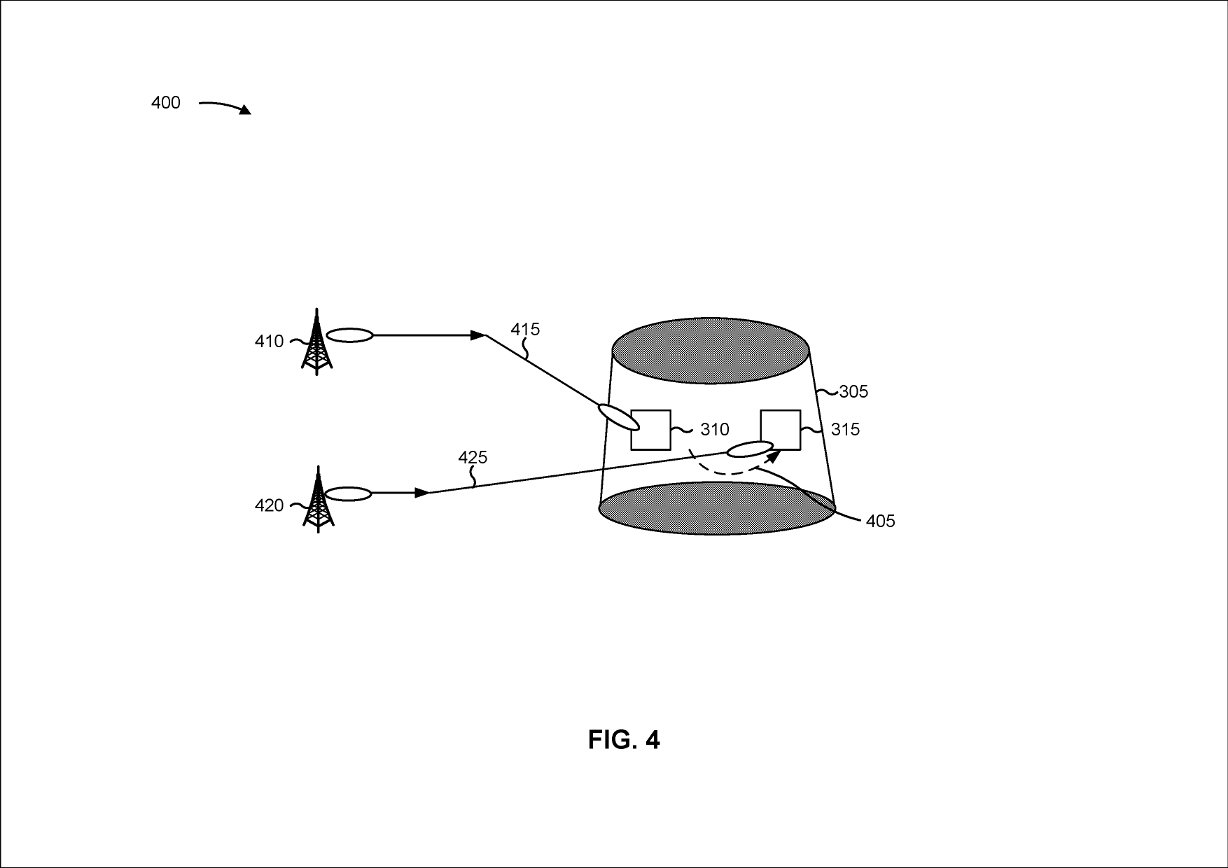

FIG. 4 is a diagram illustrating an example 400 of a device including a mechanically displaceable antenna panel, in accordance with the present disclosure. As shown in FIG. 4, the UE 305 may include the antenna panel 310 and the antenna panel 315. The antenna panel 310 and the antenna panel 315 may be mechanically displaceable (e.g., moveable or adjustable) relative to each other. The antenna panel(s) 310 and/or 315 may be displaceable via one or more mechanical apparatuses (e.g., one or more motors or other apparatuses). In some examples, both the antenna panel 310 and the antenna panel 315 may be mechanically displaceable (e.g., a physical position and/or orientation of both the antenna panel 310 and the antenna panel 315 may be displaceable, moveable, and/or adjustable). In some other examples, one or more of the antenna panels (e.g., the antenna panel 310 or the antenna panel 315) may have a fixed position or orientation (e.g., and may not be mechanically displaceable, moveable, or adjustable).

The UE 305 may include at least one antenna panel (e.g., the antenna panel 310 and/or the antenna panel 315) for which a position and/or orientation is mechanically displaceable, moveable, or adjustable. Although some examples are herein describe and/or depict two antenna panels, the UE 305 may include any quantity of antenna panels (e.g., one (e.g., a single) antenna panel, three antenna panels, four antenna panels, or another quantity of antenna panels) where at least one of the antenna panel(s) is mechanically displaceable.

As shown by reference number 405, the antenna panel 310 and/or the antenna panel 315 may be mechanically displaced via one or more mechanical apparatuses (e.g., a motor). For example, the antenna panel 310 and/or the antenna panel 315 may be mechanically rotated, displaced, or otherwise moved. The displacement of the antenna panel(s) (e.g., the antenna panel 310 and/or the antenna panel 315) may be linear and/or angular. In some examples, such as shown in FIG. 3, the antenna panel 310 and/or the antenna panel 315 may be mechanically displaced such that the antenna panel 310 and/or the antenna panel 315 can be configured to operate as co-located panels. In such examples, the UE 305 may communicate (e.g., transmit and/or receive signal(s)) via both the antenna panel 310 and/or the antenna panel 315 with a single node or device (e.g., a single UE 120 or a single network node 110).

In other examples, as shown in FIG. 4, the antenna panel 310 and/or the antenna panel 315 may be mechanically displaced such that the antenna panel 310 and/or the antenna panel 315 can be configured communicate (e.g., transmit and/or receive) signals associated with multiple nodes or devices. For example, as shown by reference number 405, the UE 305 may mechanically displace (e.g., rotate, move, and/or displace) the antenna panel 310 and/or the antenna panel 315 such that the antenna panel 310 and the antenna panel 315 are non-co-located. For example, the mechanical displacement may physically separate and/or displace the antenna panels 310 and 315 to enable the UE 305 to perform directional communications with multiple nodes or devices. For example, the mechanical displacement may cause an angular separation between the antenna panel 310 and the antenna panel 315. Such angular separation between the antenna panel 310 and the antenna panel 315 may be introduced during a mechanical alignment phase. For example, the mechanical alignment phase operation may take the UE 305 a relatively long time (for example, in the order of seconds and/or minutes) to complete and transition to communicating with the multiple nodes or devices. For example, the UE 305 may perform one or more mechanical displacements of the antenna panel 310 and/or the antenna panel 315 to decrease cross-talk and/or leakage between communications via the antenna panel 310 and communications via the antenna panel 315.

In some examples, the UE 305 may be enabled to perform full duplex and/or sub-band full duplex operations via the antenna panel 310 and the antenna panel 315. In such examples, the antenna panel 310 (or, for example, a first subset of panels of the UE 305) may communicate via a first carrier frequency, a first frequency range, and/or a first frequency band. The second antenna panel 310 (or, for example, a second subset of panels of the UE 305) may communicate via a second carrier frequency, a second frequency range, and/or a second frequency band. In such examples, the antenna panel 310 and the antenna panel 315 may be configured to transmit and/or receive signals for the same device and/or different devices.

As shown in FIG. 4, the UE 305 may communicate with a first device 410 (e.g., a network node 110, a UE 120, or another wireless communication device) via the antenna panel 310. For example, the UE 305 may transmit and/or receive one or more signals via the antenna panel 310 associated with a communication link 415 between the UE 305 and the first device 410. The UE 305 may communicate with a second device 420 (e.g., a network node 110, a UE 120, or another wireless communication device) via the antenna panel 315. For example, the UE 305 may transmit and/or receive one or more signals via the antenna panel 315 associated with a communication link 425 between the UE 305 and the second device 420.

The antenna panels of the UE 305 may be operating in accordance with various adaptive communication states. For example, In some examples, both (e.g., all or multiple) antenna panels of the UE 305 may be transmitting (e.g., may be configured to transmit signals). In other examples, both (e.g., all or multiple) antenna panels of the UE 305 may be receiving (e.g., may be configured to receive signals). In other examples, the UE 305 may be operating in a full-duplex mode in which a first one or more of the antenna panels are transmitting signals at a time that at least partially overlaps with a time during which a second one or more of the antenna panels are receiving signals. In other examples, one or more of the antenna panels of the UE 305 may be inactive or powered off. In other examples, all of the antenna panels of the UE 305 may be inactive or powered off.

However, different communication states may be associated with different mechanical displacement parameters. For example, for the UE 305 to communicate with antenna panels in a given communication state, the UE 305 may mechanically displace one or more of the antenna panels. For example, if the communication state is associated with communication with a single node or device, then the UE 305 may mechanically displace one or more of the antenna panels to be co-located (e.g., to be closer together or to be oriented in similar spatial directions). In other examples, if the communication state is associated with communication with multiple nodes or devices, then the UE 305 may mechanically displace one or more of the antenna panels to be non-co-located (e.g., to be further apart or to be oriented in different spatial directions). However, a network node (or another device communicating with the UE 305) may be unaware of the communication state(s) in which the UE 305 is capable of communicating. Moreover, the network node (or other device communicating with the UE 305) may be unaware of the current mechanical positions or orientations of the antenna panels of the UE 305.

As indicated above, FIG. 4 is provided as an example. Other examples may differ from what is described with regard to FIG. 4.

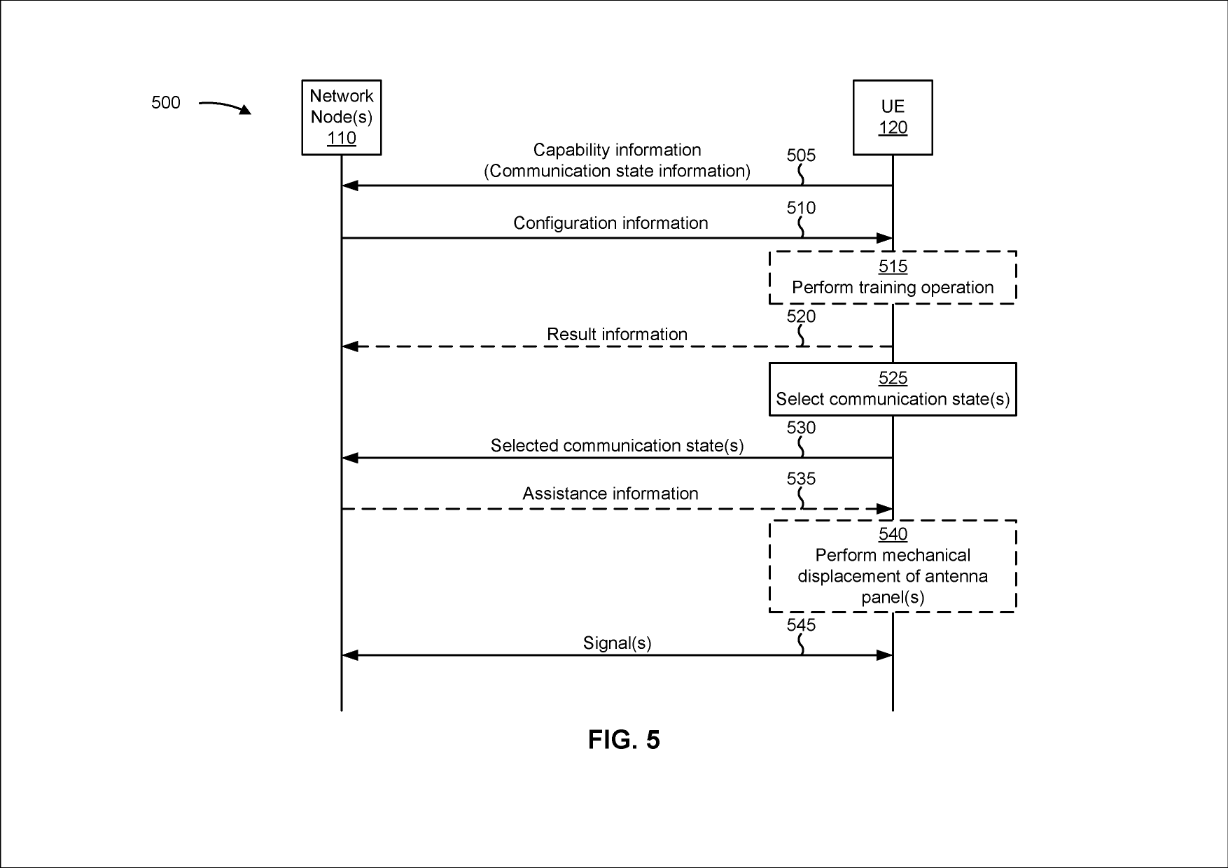

FIG. 5 is a diagram of an example 500 associated with adaptive communication states for mechanically displaceable antenna panels, in accordance with the present disclosure. As shown in FIG. 5, one or more network nodes 110 (e.g., a base station, a CU, a DU, and/or an RU) may communicate with a UE 120. In some aspects, the UE 120 may be a CPE, an MTC UE, an IoT device, a RedCap UE, the UE 305, or a similar type of device. In some aspects, the network node 110 and the UE 120 may be part of a wireless network (e.g., the wireless communication network 100). The UE 120 and the network node 110 may have established a wireless connection prior to operations shown in FIG. 5. FIG. 5 depicts an example sequence of signaling and communication operations between UE 120 and network node(s) 110 associated with the transmission and reception of capability information and/or configuration information to enable mechanical adjustments of antenna panels and adaptive communication states for the antenna panels.

As shown by reference number 505, the UE 120 may transmit capability information. The capability information may be included in a capability report. The UE may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), and/or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE supports a feature and/or one or more parameters related to the feature. For example, the capability information may indicate a capability and/or parameter for having mechanically displaceable (or adjustable or moveable or mobile) antenna panels. As another example, the capability information may indicate a capability and/or parameter for supporting one or more communication states (e.g., for respective antenna panels of the UE 120). One or more operations described herein may be based on capability information. For example, the UE may perform a communication in accordance with the capability information, or may receive configuration information that is in accordance with the capability information.

In some aspects, the UE 120 may transmit communication state information. The communication state information may be included in the capability information. Additionally, or alternatively, the communication state information may be transmitted by the UE 120 via one or more other communications. As used herein, “communication state information” may include information indicative of one or more communication states that the UE 120 is capable of operating in and/or that the UE 120 is currently configured to operate in. A “communication state” may refer to a state of one or more antenna panels of the UE 120. For example, a communication state may include a transmitting state (e.g., in which one or more antenna panels are configured to transmit signals), a receiving state (e.g., in which one or more antenna panels are configured to receive signals), an inactive state (e.g., in which one or more antenna panels are not configured to transmit or receive and/or are powered off), a half-duplex state (e.g., in which the UE 120 is configured to communicate in a half-duplex mode via one or more antenna panels), and/or a full-duplex state (e.g., in which the UE 120 is configured to communicate in a full-duplex mode via multiple antenna panels), among other examples.

The communication state information may indicate a set of one or more available communication states for respective antenna panels of the UE 120. For example, the UE 120 may determine the communication state information based on, or otherwise associated with, a range of positions and/or orientations in which respective antenna panels can be moved, rotated, displaced, and/or positioned. For example, the UE 120 may support one or more panel configurations (e.g., where a panel configuration indicates a positions and/or orientations for respective antenna panels of multiple antenna panels of the UE 120). For each panel configuration, the UE 120 may support one or more communication states.

The capability information may indicate UE support for adaptively switching between multiple communication states based on the mechanical displacements between multiple antenna panels. For example, the UE 120 may be capable of selecting the communication state for each antenna panel based on positions and/or orientations of respective antenna panels, data processing parameters (e.g., coherent or non-coherent processing), and/or measured signal leakage, among other examples, as described in more detail elsewhere herein. The capability information may indicate that the UE 120 is capable of adaptively switching communication states of respective antenna panels of the UE 120. Additionally, or alternatively, the capability information may indicate that the UE 120 is capable of mechanically displacing, rotating, tilting, and/or otherwise moving the antenna panels of the UE 120.

The network node 110 may determine configuration information for the UE 120 based on, or otherwise associated with, the capability information. For example, the network node 110 may determine one or more reference signals to be configured for the UE 120 based on the UE 120 supporting adaptive communication states for the antenna panels of the UE 120. For example, the network node 110 may configure the UE 120 to measure and/or report measurement information for one or more reference signals for various communication states and/or positions or orientations of respective antenna panels, among other examples. As another example, the network node 110 may determine one or more TCI states to be configured and/or activated for the UE 120 based on the UE 120 supporting one or more communication states (e.g., as indicated by the capability information). In other examples, the network node 110 may determine the configuration information without (or independent of) the capability information.

As shown by reference number 510, the network node 110 may transmit, and the UE 120 may receive, the configuration information. In some aspects, the UE 120 may receive the configuration information via one or more of system information (e.g., a master information block (MIB) and/or a system information block (SIB), among other examples), RRC signaling, MAC signaling (e.g., one or more MAC-CEs), and/or physical layer signaling (e.g., DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by wireless communication standard, such as the 3GPP (e.g., rather than explicitly indicating the information).

In some aspects, the configuration information may indicate that the UE 120 is to adaptively switch or change the communication states of respective antenna panels of the UE 120. For example, the configuration information may indicate that the UE 120 is to switch or change the communication states of respective antenna panels of the UE 120 based on, in response to, or otherwise associated with one or more criteria. The one or more criteria may include relative mechanical displacements of the antenna panels of the UE 120 with respect to each other, one or more data parameters or data processing parameters for communication between the UE 120 and the network node 110, and/or signal leaking measurement information, among other examples. The one or more data parameters or data processing parameters may include a type of signal processing to be performed via multiple antenna panels of the UE 120, such as coherent processing (e.g., in which the UE 120 combines signals from multiple antenna panels while preserving the antenna panels relative phases and amplitudes to enhance signal strength and/or improve reception) or non-coherent processing.

In some aspects, the configuration information may indicate that the UE 120 is to perform a training operation associated with the adaptive communication states of the antenna panels of the UE 120, as described in more detail elsewhere herein (such as in connection with reference number 515). For example, the configuration information may indicate one or more reference signal configurations and/or time domain resources to be used to perform the training operation.

In some aspects, the configuration information may include assistance information associated with facilitating communication via the multiple antenna panels. The information (e.g., assistance information) may be associated with the communication state information indicated by the UE 120. For example, information may be associated with the communication state information in that the information facilitates one or more operations at the UE 120 for one or more communication states indicated by the communication state information. For example, the information may include an indication to activate one or more TCI states. A TCI state can be configured or activated for a given communication state (e.g., of one or more antenna panels of the UE 120) by specifying beamforming parameters and/or reference signal configurations that align with the designated communication state to ensure optimal signal directionality and performance. This enables the network node 110 to dynamically adjust beam configurations to correspond to the current communication state(s) of the antenna panel(s) and the position(s) or orientation(s) of the antenna panel(s). For example, the one or more TCI states may enable coordinated transmission or reception, by the UE 120, with the network node 110 (and/or one or more TRPs or nodes associated with the network node 110). A TCI state enables coordinated transmission or reception by providing a common reference for beamforming parameters and/or scheduling across multiple transmission points, ensuring that transmitted signals from different nodes are aligned in phase and time at the UE 120. This synchronization enhances signal strength and reduces interference, allowing multiple nodes to work collectively in delivering coherent and efficient communications to the UE 120.

In some aspects, the information (e.g., the assistance information) may include a configuration of one or more reference signals associated with beam configurations for coherent transmission or reception. For example, the network node 110 may transmit, and the UE 120 may receive, reference signal configurations for beam determination for coherent transmission and/or reception at the UE 120 across multiple antenna panels. This enables the UE 120 to receive (and/or measure) and/or transmit the reference signals using multiple antenna panels (e.g., that are mechanically positioned or located for coherent communication). The transmission or reception of the one or more reference signals may enable the UE 120 or the network node 110 to obtain measurement information that can be used to adjust one or more communication parameters for the coherent transmission or reception when the multiple antenna panels are mechanically positioned or located for coherent communication. Additionally, or alternatively, the measurement information that can be used to adjust the position and/or orientation of at least one antenna panel of the UE 120 for the coherent transmission or reception. This enables the UE 120 to determine one or more transmission beams or reception beams to be used for a given antenna panel configuration and for a communication state associated with coherent transmission or reception. The reference signals may include CSI-RSs, SSBs, and/or other reference signals. The UE 120 may determine the best beam for coherent transmission or reception by measuring quality metrics of the reference signals (such as signal-to-noise ratio (SNR) or RSRP). Based on these measurements, the UE 120 can select the most optimal beam configurations, adjusting a phase and/or amplitude for one or more antenna elements to align with the desired transmission or reception direction, thereby enhancing signal strength and reliability for coherent transmission or reception.

In some aspects, the configuration information may indicate a placement for one or more antenna panels of the multiple antenna panels of the UE 120. The placement may be associated with enabling one or more communication states indicated by the communication state information. For example, the communication state information may indicate available or possible communication states in which the UE 120 can operate. The network node 110 may determine a communication state (e.g., coherent transmission, coherent reception, half-duplex, full-duplex, among other examples) in which the UE 120 is to operate (e.g., from the available or possible communication states indicated by the UE 120). The configuration information may include instructions to mechanically displace or adjust the position or orientation of one or more antenna panels of the UE 120 to enable the UE 120 to communicate in the communication state (e.g., that is selected or determined by the network node 110).

The UE 120 may configure itself based at least in part on the configuration information. In some aspects, the UE 120 may be configured to perform one or more operations described herein based at least in part on the configuration information.

In some aspects, as shown by reference number 515, the UE 120 may perform a training operation for the mechanical displacement and/or adaptive communication states for the antenna panels of the UE 120. For example, the UE 120 may perform the training operation evaluate performance levels in various communication states or mechanical displacements of the antenna panels of the UE 120. The training operation may include the UE 120 transmitting and/or receiving signals in one or more communication states and/or one or more antenna placement configurations for respective antenna panels of the multiple antenna panels of the UE 120.

For example, during the training operation, the UE 120 may transmit or receive one or more signals (such as reference signal(s) configured via the configuration information) using one or more communication states and/or one or more antenna placement configurations (e.g., configurations of positions and/or orientations) of the antenna panels of the UE 120. In some aspects, the UE 120 may obtain result information for the training operation. The result information may be indicative of a performance level of the UE 120 in at least one of different communication states or different mechanical displacements of the multiple antenna panels. In some aspects, the result information may include measurement information of the signal(s) transmitted or received by the UE 120, such as SNR measurements, RSRP measurements, RSRQ measurements, or another type of measurement.

In some aspects, the result information may include signal leakage measurement information. For example, the UE 120 may measure signal leakage associated with the multiple antenna panels during operation in various communication states or various mechanical displacements of the multiple antenna panels. The UE 120 may measure signal leakage between antenna panels by monitoring and comparing the received signal quality metrics (such as signal-to-interference-plus-noise ratio (SINR) or RSRQ), across different antenna panels. By evaluating the interference levels and signal degradation experienced by each antenna panel when other panels are transmitting, the UE 120 can quantify the extent of signal leakage and optimize the antenna placement configurations to minimize interference and enhance overall communication performance.

In some aspects, the UE 120 may store the result information. For example, the UE 120 may determine the communication state information described herein based on the result information. For example, the UE 120 may determine possible or available communication states based on the result information (e.g., if a communication state is associated with a performance level that satisfies a performance threshold, then the communication state may be available for use by the UE 120). As an example, if the UE obtains one or more measurements in a communication state and antenna placement configuration wherein the one or more measurements satisfy a measurement threshold, then that communication state may be available for use for that antenna placement configuration.

In some aspects, as shown by reference number 520, the UE 120 may transmit, and the network node 110 may receive, the result information. For example, the UE 120 may transmit an indication of the performance levels of the UE 120 in various communication states and antenna placement configurations of the UE 120. Additionally, or alternatively, the network node 110 may obtain the result information, such as by measuring one or more signals transmitted by the UE 120 during the training stage, as described elsewhere herein. The network node 110 may use the result information to determine an optimal communication state and/or antenna placement configuration for the multiple antenna panels of the UE 120 based on current network conditions and/or data requirements, among other examples.

In some aspects, as shown by reference number 525, the UE 120 may select one or more communication states for one or more antenna panels of the UE 120. The UE 120 may select the one or more communication states based on, or otherwise associated with, a current antenna placement configuration of the UE 120. For example, the UE 120 may select the one or more communication states based on, or otherwise associated with, relative mechanical displacements between the multiple antenna panels. The relative mechanical displacements may be a linear displacement and/or an angular displacement between two or more antenna panels. In some aspects, the UE 120 may select the one or more communication states based on, or otherwise associated with, the communication state information and the configuration information. For example, the configuration information (or another communication received from the network node 110) may indicate a type of communication (e.g., transmit, receive, half-duplex, or full-duplex) to be performed by the UE 120. The UE 120 may select the communication state(s) based on the type of communication.

In some aspects, the UE 120 may select one or more communication states based on the evaluated performance (e.g., during the training operation described in connection with reference number 515) and the current mechanical displacement of the antenna panels of the UE 120. For example, the UE 120 may select the communication state for each antenna panel of the UE 120. The selection of the communication state for each antenna panel may be based on, or otherwise associated with, the current antenna placement configuration of the UE 120 (e.g., the current mechanical positions and/or orientations of the antenna panels). Additionally, or alternatively, the selection of the communication state for each antenna panel may be based on, or otherwise associated with, one or more data parameters for uplink channel communications or downlink channel communications. The one or more data parameters may include one or more data processing requirements for one or more channels (e.g., an uplink channel or a downlink channel), such as coherent processing or non-coherent processing. The one or more data parameters may be indicated by the configuration information. Additionally, or alternatively, the selection of the communication state for each antenna panel may be based on, or otherwise associated with, measured signal leakage between antenna panels operating in different communication states.

For example, the UE 120 may measure signal leakage associated with the multiple antenna panels, as described in more detail elsewhere herein. The UE 120 may identify, based on the signal leakage, one or more antenna placement configurations for respective communication states from one or more communication states indicated by the communication state information. The UE 120 may select the one or more communication states based on the current antenna placement configuration and signal leakage measured for the current antenna placement configuration. For example, if the signal leakage measurement does not satisfy a threshold, then a full-duplex communication state can be selected for the current antenna placement configuration. However, if the signal leakage measurement satisfies the threshold, then the full-duplex communication state may not be selected for the current antenna placement configuration. This increases the likelihood that the signal leakage experienced by the UE 120 for a given antenna placement configuration does not result in degraded performance for the UE 120.

In some aspects, as shown by reference number 530, the UE 120 may transmit and the network node 110 may receive, an indication of the selected communication state(s) for the antenna panels of the UE 120. For example, the UE 120 may indicate a dynamic selection of communication states across antenna panels from the one or more communication states indicated by the communication state information and/or the capability information. The UE 120 may transmit the indication of the selected communication state(s) via an uplink signal, a PUCCH signal, a PUSCH signal, an uplink MAC-CE, uplink control information, and/or capability signaling, among other examples.

Additionally, or alternatively, the network node 110 may transmit, and the UE 120 may receive, an indication to perform a mechanical displacement of one or more antenna panels to enable one or more communication states. For example, the network node 110 may determine that the UE 120 is to operate in a full-duplex mode. The network node 110 may transmit, and the UE 120 may receive, an indication to place the antenna panels of the UE 120 in an antenna placement configuration in which a full-duplex communication state is permissible (e.g., based on measured signal leakage and/or other result information described herein). As another example, the network node 110 may transmit, and the UE 120 may receive, an indication to place the antenna panels of the UE 120 in an antenna placement configuration in which non-coherent communication with multiple nodes or devices is permissible (e.g., based on measured signal leakage and/or other result information described herein).

In some aspects, as shown by reference number 535, the network node 110 may transmit, and the UE 120 may receive, assistance information that is based on the selected communication state(s) (e.g., selected by the UE 120) and/or the communication state(s) indicated by the network node 110. As described in more detail elsewhere herein, the assistance information may include information or signals to facilitate operation by the UE 120 in one or more communication states. The network node 110, after receiving the selected communication state(s), may transmit assistance information to the UE 120. The assistance information may include reference signals associated with beam configurations for coherent transmission or reception, and/or an activation of one or more TCI states, among other examples.

For example, the network node 110 may transmit, and the UE 120 may receive, one or more reference signals (e.g., configured via the configuration information) to enable beam determinations by the UE 120. The UE 120 may measure the one or more reference signals in a current antenna placement configuration to determine one or more beam parameters (e.g., antenna element phases and/or gains) to optimize performance for the selected or indicated communication state(s) and the current antenna placement configuration.

As another example, the assistance information may include an indication to activate or apply one or more TCI states. For example, a beam may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each transmit beam of the network node 110 (or another TRP or device) may be associated with an SSB. A given SSB may have an associated TCI state (for example, for an antenna port for beamforming). The network node 110 may, in some examples, indicate one or more downlink beams based at least in part on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a receive beam at the UE 120. Thus, the UE 120 may select a corresponding receive beam based at least in part on the network node 110 indicating a transmit beam via a TCI state. Therefore, the UE 120 may use the one or more activated TCI states to configure the multiple antenna panels in the current antenna panel placement configuration.

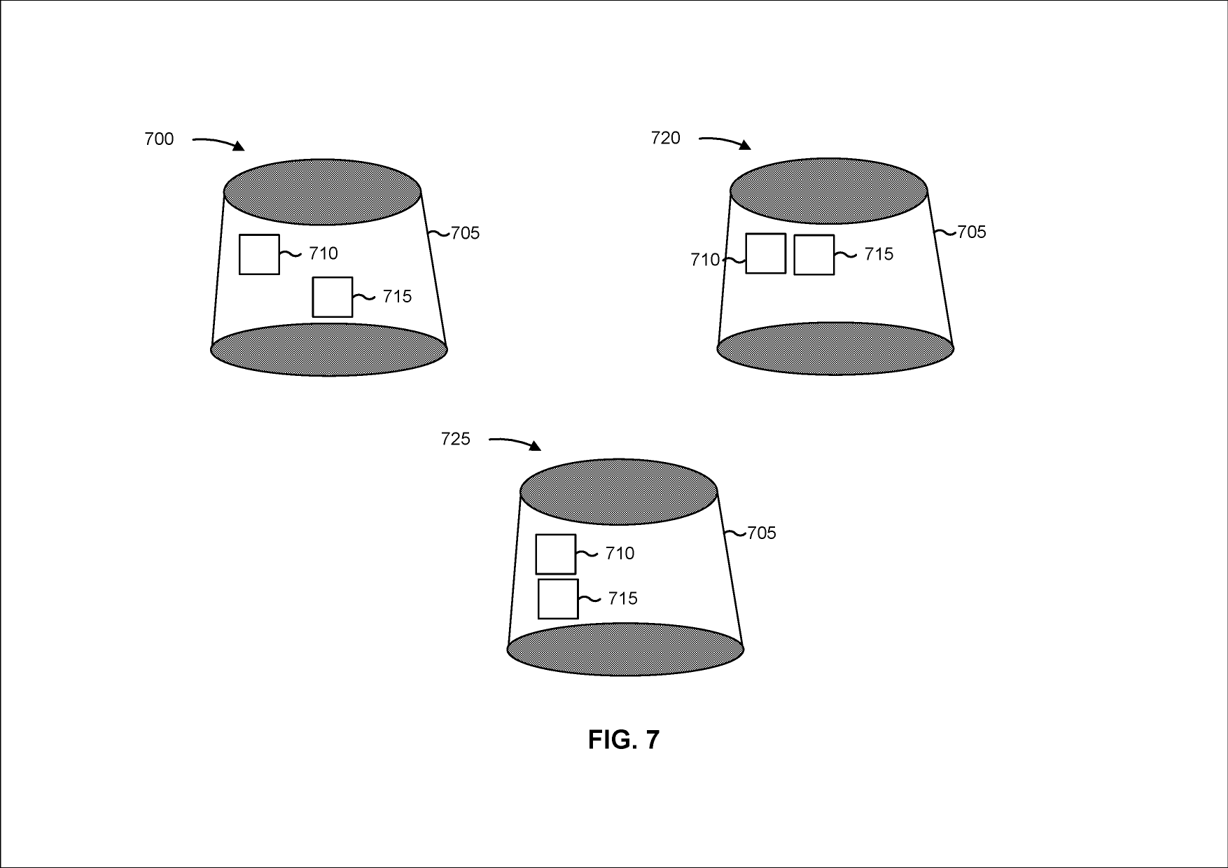

In some aspects, as shown by reference number 540, the UE 120 may perform a mechanical displacement of one or more antenna panels. The mechanical displacement may include rotating, displacing, tilting, and/or otherwise moving one or more antenna panels. For example, the UE 120 may identify an antenna placement configuration that is optimal for selected or indicated communication state(s) of the multiple antenna panels. The UE 120 may cause one or more mechanical apparatuses (e.g., one or more motors) to mechanically displace or adjust a position or orientation of one or more antenna panels. For example, the UE 120 may perform, prior to communicating one or more signals, a mechanical adjustment of one or more antenna panels in accordance with an antenna placement configuration from one or more antenna placement configurations. The antenna placement configuration may be associated with a communication state (e.g., that is selected by the UE 120 or indicated by the network node 110). For example, the UE 120 may be configured to communicate one or more signals in accordance with the communication state(s). The mechanical placements and/or position of the antenna panels of the UE 120 is depicted and described in more detail elsewhere herein, such as in connection with FIG. 7.

In some aspects, if the UE 120 adjusts or modifies an antenna placement configuration of the multiple antenna panels, then the UE 120 may transmit, and the network node 110 may receive, updated communication state information. For example, the UE 120 may transmit, and the network node 110 may receive, updated communication state information indicating a modification to the one or more possible communication states in association with one or more changes in the relative mechanical displacements. For example, in an updated antenna placement configuration the UE 120 one or more communication states may no longer be suitable and/or may now be suitable. The UE 120 may transmit the updated communication state information to indicate to the network node 110 the update possible communication state(s) that the UE can communicate in for the updated antenna placement configuration.

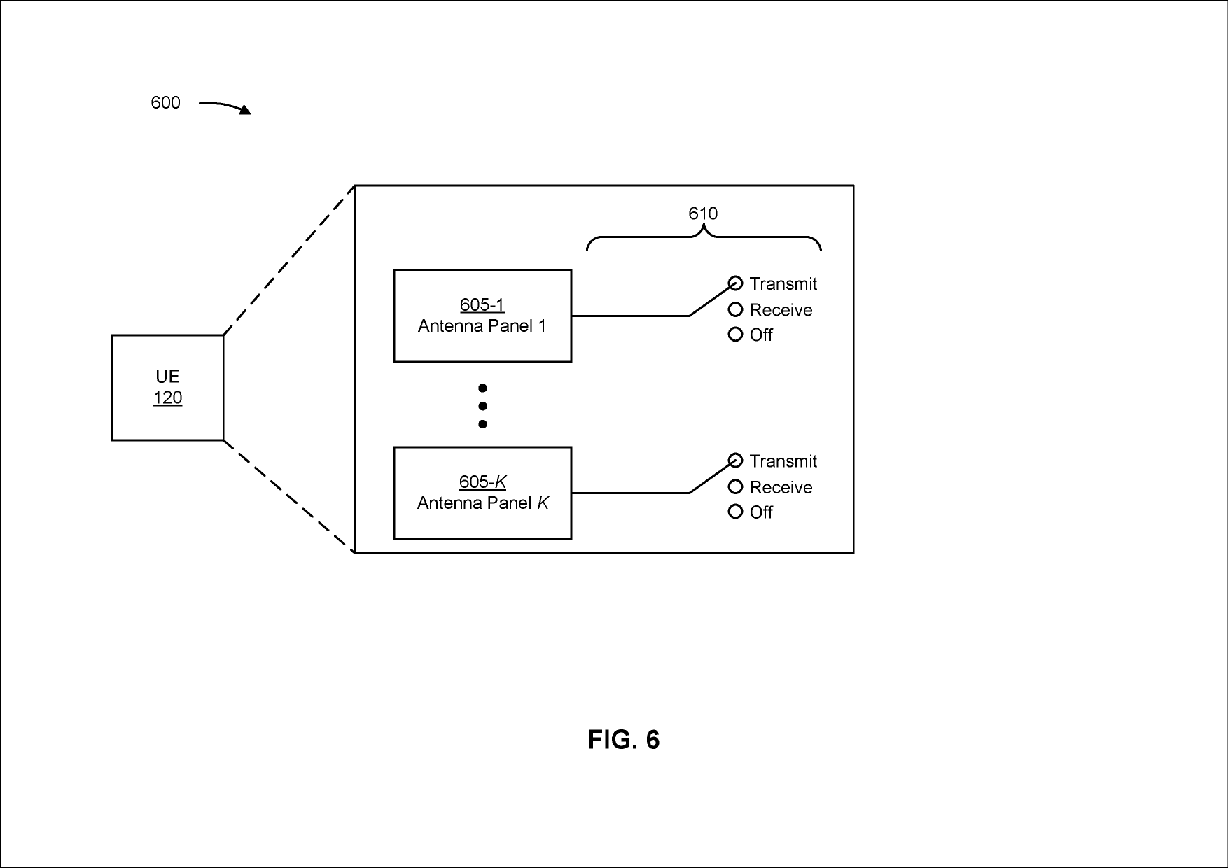

As shown by reference number 545, the UE 120 and the network node 110 may communicate one or more signals. In some aspects, the UE 120 may transmit, and the network node 110 may receive, one or more signals. Additionally, or alternatively, the network node 110 may transmit, and the UE 120 may receive, one or more signals. The UE 120 may communicate in accordance with the communication state information and/or the selected or indicated communication state(s). For example, the UE 120 may communicate with antenna panels configured in respective communication states (e.g., as depicted and described in more detail in connection with FIG. 6). Additionally, the UE 120 may communicate with the antenna panels positioned or oriented in a given antenna placement configuration (e.g., as depicted and described in more detail in connection with FIG. 7).

By coordinating the communication state(s) of the antenna panels with the network node 110, as described in more detail elsewhere herein, communication performance of the UE 120 may be improved because the UE 120 may use communication states of respective antenna panels that are optimized or selected based on a current antenna placement configuration of the UE 120. By accounting for the relative mechanical displacements between the multiple antenna panels, the UE 120 and the network node 110 may improve the performance of signals transmitted and/or received by the UE 120 via the multiple antenna panels.

As indicated above, FIG. 5 is provided as an example. Other examples may differ from what is described with regard to FIG. 5.

FIG. 6 is a diagram of an example 600 associated with adaptive communication states for antenna panels. As shown in FIG. 6, the UE 120 may include multiple antenna panels 605 (shown as antenna panel 605-1 through antenna panel 605-K). For example, as shown in FIG. 6, the UE 120 may include K antenna panels (e.g., where K is greater than or equal to two).

As shown in FIG. 6, each antenna panel 605 may be associated with a switching component 610 that facilitates transition between various communication states, such as transmit, receive, and off (or inactive), in a similar manner as described in more detail elsewhere herein. For example, the switching component 610 may include a mixer for each intermediate frequency (IF) or RF signal chain for a given antenna panel 605. A mixer in the signal chain per IF/RF signal enables communication state switching for a given antenna panel 605 by dynamically converting the frequency of a signal to the desired IF or RF for different communication states. For example, the mixer can facilitate the transition between transmitting and receiving states by adjusting the frequency and phase characteristics of the signal, allowing seamless switching while maintaining the optimal performance of the antenna panel 605 for the current communication requirements. This flexibility supports various modes, such as full-duplex, half-duplex, and different frequency bands, enhancing the UE's adaptability in diverse network scenarios.

For example, as shown in FIG. 6, each antenna panel 605 can be independently set or configured to operate in a given communication state (e.g., transmit, receive, or off). Therefore, in examples where the UE 120 includes K antenna panels 605, there may be 3K communication state possibilities for the K antenna panels 605. In some aspects, the communication state information described herein may indicate the 3K communication state possibilities.

For example, the UE 120 may transmit communication state information related to the antenna panels 605, indicating the capability to switch between multiple communication states based on the relative mechanical positions of the antenna panels 605. The UE 120 transmitting the communication state information may enable efficient and adaptive signal communication. In some aspects, a subset of the 3K communication state possibilities may be available or possible for certain antenna placement configurations. For example, when the multiple antenna panels 605 are positioned or oriented in a certain physical configuration, one or more of the 3K communication state possibilities may not be suitable. For example, one or more communication states of the 3K communication state possibilities may result in signal leakage measurements that satisfy a signal leakage threshold (e.g., indicating that operating in the one or more communication states for the certain physical configuration may result in signal leakage that degrades performance of the UE 120). As described elsewhere herein, the communication state information may indicate the subset of the 3K communication state possibilities for the current antenna placement configuration of the UE 120. This reduces the likelihood of the network node 110 attempting to communicate with the UE 120 in a manner that results in degraded performance, such as due to the signal leakage or cross talk.

As indicated above, FIG. 6 is provided as an example. Other examples may differ from what is described with regard to FIG. 6.

FIG. 7 is a diagram illustrating an example of various antenna placement configurations. For example, as shown in FIG. 7, a UE 705 (e.g., the UE 120 described in connection with FIG. 5, FIG. 6, and/or elsewhere herein) may include an antenna panel 710 and an antenna panel 715. The UE 120 may mechanically position or orient the antenna panel 710 and the antenna panel 715 in a first antenna placement configuration 700, a second antenna placement configuration 720, and a third antenna placement configuration 725, as examples. The antenna placement configurations may be optimized panel placements to minimize signal leakage between antenna panels, and to enable flexible transmission or reception with all antenna panels (e.g., in a coherent or non-coherent manner). The antenna placement configurations depicted and described in FIG. 7 are provided as examples and other antenna placement configurations are possible.

As an example, the first antenna placement configuration 700 may be configured to enable full-duplex communication or operation at the UE 705. For example, as described elsewhere herein, the UE 705 may measure signal leakage during operation in various antenna placement configurations. The UE 705 may identify or select the first antenna placement configuration 700 for full-duplex communication or operation at the UE 705 because a measured signal leakage between the antenna panel 710 and the antenna panel 715 may be less than or equal to a threshold (or is associated with a lowest measured signal leakage among multiple measured signal leakages for respective antenna placement configurations). This may reduce a likelihood of degraded performance (e.g., due to signal leakage) when both the antenna panel 710 and the antenna panel 715 are operating at the same time and in different communication states (e.g., in which the antenna panel 710 is configured in a transmit state and the antenna panel 715 is configured in a receive state, or vice versa).

The second antenna placement configuration 720 depicts another arrangement where the antenna panel 710 and the antenna panel 715 are positioned adjacently. This arrangement may be employed for scenarios requiring close interaction or coherency between the antenna panels 710 and 715, optimizing the combined signal strength while managing potential leakage. For example, the second antenna panel configuration 720 may enable transmission or reception by both the antenna panel 710 and the antenna panel 715.

The third antenna placement configuration 725 represents another configuration of the first antenna panel 710 and the second antenna panel 715 of the UE 705. This alignment of the panels offers an alternative mechanical displacement, which might be utilized for operational states that demand a compact form factor and efficient signal handling. For example, the third antenna placement configuration 725 may be an azimuth or horizontal rotation relative to the second antenna placement configuration 720. Azimuth rotation refers to the horizontal angular movement or adjustment of an antenna panel around a vertical axis. In the context of antenna panels, azimuth rotation allows the direction of the beam of the antenna to be changed horizontally, which can be used to align with a given transmitter or receiver (e.g., a given spatial direction or TCI state), optimize signal strength, reduce interference, and/or improve overall communication performance. This adjustment may be beneficial for applications such as beamforming and mechanically steerable antenna systems. For example, the second antenna placement configuration 720 and the third antenna placement configuration 725 may depict antenna placement configurations that can be easily or quickly displaced to enable transmission or reception for all antenna panels (e.g., the antenna panels 710 and 715) of the UE 705 (e.g., via azimuth or horizontal rotation of the antenna panels).

These various antenna placement configurations enable the UE 705 to dynamically and adaptively adjust to different communication states and requirements, minimizing interference and optimizing performance. The mechanical displacements of the multiple antenna panels facilitate efficient switching and operation under diverse conditions based on, or otherwise associated with the communication state information and signal leakage measurements described in more detail elsewhere herein.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120 or a CPE) performs operations associated with adaptive communication states for mechanically displaceable antenna panels.

As shown in FIG. 8, in some aspects, process 800 may include transmitting communication state information for multiple antenna panels of the UE, wherein the multiple antenna panels are mechanically displaceable relative to each other, and wherein the communication state information is based on relative mechanical displacements between the multiple antenna panels (block 810). For example, the UE (e.g., using transmission component 1004 and/or communication manager 1006, depicted in FIG. 10) may transmit communication state information for multiple antenna panels of the UE, wherein the multiple antenna panels are mechanically displaceable relative to each other, and wherein the communication state information is based on relative mechanical displacements between the multiple antenna panels, as described above.

As further shown in FIG. 8, in some aspects, process 800 may include communicating, via at least one antenna panel of the multiple antenna panels, one or more signals in accordance with the communication state information (block 820). For example, the UE (e.g., using reception component 1002, transmission component 1004, and/or communication manager 1006, depicted in FIG. 10) may communicate, via at least one antenna panel of the multiple antenna panels, one or more signals in accordance with the communication state information, as described above.

Process 800 may include additional aspects, such as any single aspect or any combination of aspects described below and/or in connection with one or more other processes described elsewhere herein.

In a first aspect, transmitting the communication state information includes transmitting an indication of a capability of the UE to adaptively switch between multiple communication states based on the relative mechanical displacements, wherein the communication state information indicates the capability.

In a second aspect, alone or in combination with the first aspect, the communication state information indicates a set of available communication states for respective antenna panels of the multiple antenna panels.

In a third aspect, alone or in combination with one or more of the first and second aspects, the set of available communication states include at least one of a transmitting state, a receiving state, an inactive state, a half-duplex state, or a full-duplex state.

In a fourth aspect, alone or in combination with one or more of the first through third aspects, the communication state information is associated with one or more data parameters for one or more channels.

In a fifth aspect, alone or in combination with one or more of the first through fourth aspects, process 800 includes measuring signal leakage associated with the multiple antenna panels, where the communication state information is associated with the signal leakage.

In a sixth aspect, alone or in combination with one or more of the first through fifth aspects, process 800 includes identifying, based on the signal leakage, one or more antenna placement configurations for respective communication states from one or more communication states indicated by the communication state information, and performing, prior to communicating the one or more signals, a mechanical adjustment of the multiple antenna panels in accordance with an antenna placement configuration from the one or more antenna placement configurations, the antenna placement configuration is associated with a communication state from the one or more communication states, and the one or more signals are to be communicated in accordance with the communication state.

In a seventh aspect, alone or in combination with one or more of the first through sixth aspects, transmitting the communication state information includes transmitting capability information indicating one or more possible communication states associated with the multiple antenna panels based on the relative mechanical displacements.

In an eighth aspect, alone or in combination with one or more of the first through seventh aspects, process 800 includes transmitting updated communication state information indicating a modification to the one or more possible communication states in association with one or more changes in the relative mechanical displacements.

In a ninth aspect, alone or in combination with one or more of the first through eighth aspects, transmitting the communication state information includes transmitting an indication of one or more communication states to be used by the UE, where the one or more communication states are for respective antenna panels of the multiple antenna panels.

In a tenth aspect, alone or in combination with one or more of the first through ninth aspects, process 800 includes receiving, from a network node, assistance information associated with facilitating communication via the multiple antenna panels, where the information is associated with the communication state information.

In an eleventh aspect, alone or in combination with one or more of the first through tenth aspects, the assistance information includes an indication to activate one or more TCI states.

In a twelfth aspect, alone or in combination with one or more of the first through eleventh aspects, the assistance information includes a configuration of one or more reference signals associated with beam configurations for coherent transmission or reception.

In a thirteenth aspect, alone or in combination with one or more of the first through twelfth aspects, process 800 includes receiving, from a network node, an indication of a placement for one or more antenna panels of the multiple antenna panels, where the placement is associated with enabling one or more communication states indicated by the communication state information.

In a fourteenth aspect, alone or in combination with one or more of the first through thirteenth aspects, process 800 includes performing, in accordance with the placement, a mechanical displacement of the one or more antenna panels.

In a fifteenth aspect, alone or in combination with one or more of the first through fourteenth aspects, process 800 includes evaluating, during a training stage, a performance level of the UE in at least one of different communication states or different mechanical displacements of the multiple antenna panels, where the communication state information is associated with the performance level.

In a sixteenth aspect, alone or in combination with one or more of the first through fifteenth aspects, communicating the one or more signals includes transmitting, via a first antenna panel of the multiple antenna panels, a first signal, of the one or more signals, at a first time, and receiving, via a second antenna panel of the multiple antenna panels, a second signal, of the one or more signals, at a second time that at least partially overlaps with the first time.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with adaptive communication states for mechanically displaceable antenna panels.

As shown in FIG. 9, in some aspects, process 900 may include receiving communication state information for multiple antenna panels of a UE, wherein the multiple antenna panels are mechanically displaceable, and wherein the communication state information is based on relative mechanical displacements between the multiple antenna panels (block 910). For example, the network node (e.g., using reception component 1102 and/or communication manager 1106, depicted in FIG. 11) may receive communication state information for multiple antenna panels of a UE, wherein the multiple antenna panels are mechanically displaceable, and wherein the communication state information is based on relative mechanical displacements between the multiple antenna panels, as described above.

As further shown in FIG. 9, in some aspects, process 900 may include communicating, for the UE, one or more signals in accordance with the communication state information (block 920). For example, the network node (e.g., using reception component 1102, transmission component 1104, and/or communication manager 1106, depicted in FIG. 11) may communicate, for the UE, one or more signals in accordance with the communication state information, as described above.

Process 900 may include additional aspects, such as any single aspect or any combination of aspects described below and/or in connection with one or more other processes described elsewhere herein.

In a first aspect, receiving the communication state information includes receiving an indication of a capability of the UE to adaptively switch between multiple communication states based on the relative mechanical displacements, wherein the communication state information indicates the capability.

In a second aspect, alone or in combination with the first aspect, the communication state information indicates a set of available communication states for respective antenna panels of the multiple antenna panels.

In a third aspect, alone or in combination with one or more of the first and second aspects, the set of available communication states include at least one of a transmitting state, a receiving state, an inactive state, a half-duplex state, or a full-duplex state.

In a fourth aspect, alone or in combination with one or more of the first through third aspects, the communication state information is associated with one or more data parameters for one or more channels.

In a fifth aspect, alone or in combination with one or more of the first through fourth aspects, receiving the communication state information includes receiving capability information indicating one or more possible communication states associated with the multiple antenna panels based on the relative mechanical displacements.

In a sixth aspect, alone or in combination with one or more of the first through fifth aspects, process 900 includes receiving updated communication state information indicating a modification to the one or more possible communication states in association with one or more changes in the relative mechanical displacements.

In a seventh aspect, alone or in combination with one or more of the first through sixth aspects, receiving the communication state information includes receiving an indication of one or more communication states to be used by the UE, where the one or more communication states are for respective antenna panels of the multiple antenna panels.

In an eighth aspect, alone or in combination with one or more of the first through seventh aspects, process 900 includes transmitting assistance information associated with facilitating communication via the multiple antenna panels, where the information is associated with the communication state information.

In a ninth aspect, alone or in combination with one or more of the first through eighth aspects, the assistance information includes an indication to activate one or more TCI states.

In a tenth aspect, alone or in combination with one or more of the first through ninth aspects, the assistance information includes a configuration of one or more reference signals associated with beam configurations for coherent transmission or reception.

In an eleventh aspect, alone or in combination with one or more of the first through tenth aspects, process 900 includes transmitting an indication of a placement for one or more antenna panels of the multiple antenna panels, where the placement is associated with enabling one or more communication states indicated by the communication state information.

In a twelfth aspect, alone or in combination with one or more of the first through eleventh aspects, process 900 includes receiving an indication of a performance level of the UE in at least one of different communication states or different mechanical displacements of the multiple antenna panels, where the communication state information is associated with the performance level.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit communication state information for multiple antenna panels of the UE, wherein the multiple antenna panels are mechanically displaceable relative to each other, and wherein the communication state information is based on relative mechanical displacements between the multiple antenna panels. The reception component 1002 and/or the transmission component 1004 may communicate, via at least one antenna panel of the multiple antenna panels, one or more signals in accordance with the communication state information.

The communication manager 1006 may measure signal leakage associated with the multiple antenna panels, wherein the communication state information is associated with the signal leakage.

The communication manager 1006 may identify, based on the signal leakage, one or more antenna placement configurations for respective communication states from one or more communication states indicated by the communication state information.

The communication manager 1006 may perform, prior to communicating the one or more signals, a mechanical adjustment of the multiple antenna panels in accordance with an antenna placement configuration from the one or more antenna placement configurations, wherein the antenna placement configuration is associated with a communication state from the one or more communication states, and wherein the one or more signals are to be communicated in accordance with the communication state.

The transmission component 1004 may transmit updated communication state information indicating a modification to the one or more possible communication states in association with one or more changes in the relative mechanical displacements.

The reception component 1002 may receive, from a network node, assistance information associated with facilitating communication via the multiple antenna panels, wherein the information is associated with the communication state information.

The reception component 1002 may receive, from a network node, an indication of a placement for one or more antenna panels of the multiple antenna panels, wherein the placement is associated with enabling one or more communication states indicated by the communication state information.

The communication manager 1006 may perform, in accordance with the placement, a mechanical displacement of the one or more antenna panels.

The communication manager 1006 may evaluate, during a training stage, a performance level of the UE in at least one of different communication states or different mechanical displacements of the multiple antenna panels, wherein the communication state information is associated with the performance level.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive communication state information for multiple antenna panels of a UE, wherein the multiple antenna panels are mechanically displaceable, and wherein the communication state information is based on relative mechanical displacements between the multiple antenna panels. The reception component 1102 and/or the transmission component 1104 may communicate, for the UE, one or more signals in accordance with the communication state information.

The reception component 1102 may receive updated communication state information indicating a modification to the one or more possible communication states in association with one or more changes in the relative mechanical displacements.

The transmission component 1104 may transmit assistance information associated with facilitating communication via the multiple antenna panels, wherein the information is associated with the communication state information.

The transmission component 1104 may transmit an indication of a placement for one or more antenna panels of the multiple antenna panels, wherein the placement is associated with enabling one or more communication states indicated by the communication state information.

The reception component 1102 may receive an indication of a performance level of the UE in at least one of different communication states or different mechanical displacements of the multiple antenna panels, wherein the communication state information is associated with the performance level.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting communication state information for multiple antenna panels of the UE, wherein the multiple antenna panels are mechanically displaceable relative to each other, and wherein the communication state information is based on relative mechanical displacements between the multiple antenna panels; and communicating, via at least one antenna panel of the multiple antenna panels, one or more signals in accordance with the communication state information.

Aspect 2: The method of Aspect 1, wherein transmitting the communication state information comprises: transmitting an indication of a capability of the UE to adaptively switch between multiple communication states based on the relative mechanical displacements, wherein the communication state information indicates the capability.

Aspect 3: The method of any of Aspects 1-2, wherein the communication state information indicates a set of available communication states for respective antenna panels of the multiple antenna panels.

Aspect 4: The method of Aspect 3, wherein the set of available communication states include at least one of: a transmitting state, a receiving state, an inactive state, a half-duplex state, or a full-duplex state.

Aspect 5: The method of any of Aspects 1-4, wherein the communication state information is associated with one or more data parameters for one or more channels.

Aspect 6: The method of any of Aspects 1-5, further comprising: measuring signal leakage associated with the multiple antenna panels, wherein the communication state information is associated with the signal leakage.

Aspect 7: The method of Aspect 6, further comprising: identifying, based on the signal leakage, one or more antenna placement configurations for respective communication states from one or more communication states indicated by the communication state information; and performing, prior to communicating the one or more signals, a mechanical adjustment of the multiple antenna panels in accordance with an antenna placement configuration from the one or more antenna placement configurations, wherein the antenna placement configuration is associated with a communication state from the one or more communication states, and wherein the one or more signals are to be communicated in accordance with the communication state.

Aspect 8: The method of any of Aspects 1-7, wherein transmitting the communication state information comprises: transmitting capability information indicating one or more possible communication states associated with the multiple antenna panels based on the relative mechanical displacements.

Aspect 9: The method of Aspect 8, further comprising: transmitting updated communication state information indicating a modification to the one or more possible communication states in association with one or more changes in the relative mechanical displacements.

Aspect 10: The method of any of Aspects 1-9, wherein transmitting the communication state information comprises: transmitting an indication of one or more communication states to be used by the UE, wherein the one or more communication states are for respective antenna panels of the multiple antenna panels.

Aspect 11: The method of any of Aspects 1-10, further comprising: receiving, from a network node, assistance information associated with facilitating communication via the multiple antenna panels, wherein the information is associated with the communication state information.

Aspect 12: The method of Aspect 11, wherein the assistance information includes an indication to activate one or more transmission configuration indicator (TCI) states.

Aspect 13: The method of any of Aspects 11-12, wherein the assistance information includes a configuration of one or more reference signals associated with beam configurations for coherent transmission or reception.

Aspect 14: The method of any of Aspects 1-13, further comprising: receiving, from a network node, an indication of a placement for one or more antenna panels of the multiple antenna panels, wherein the placement is associated with enabling one or more communication states indicated by the communication state information.

Aspect 15: The method of Aspect 14, further comprising: performing, in accordance with the placement, a mechanical displacement of the one or more antenna panels.

Aspect 16: The method of any of Aspects 1-15, further comprising: evaluating, during a training stage, a performance level of the UE in at least one of different communication states or different mechanical displacements of the multiple antenna panels, wherein the communication state information is associated with the performance level.

Aspect 17: The method of any of Aspects 1-16, wherein communicating the one or more signals comprises: transmitting, via a first antenna panel of the multiple antenna panels, a first signal, of the one or more signals, at a first time; and receiving, via a second antenna panel of the multiple antenna panels, a second signal, of the one or more signals, at a second time that at least partially overlaps with the first time.

Aspect 18: A method of wireless communication performed by a network node, comprising: receiving communication state information for multiple antenna panels of a user equipment (UE), wherein the multiple antenna panels are mechanically displaceable, and wherein the communication state information is based on relative mechanical displacements between the multiple antenna panels; and communicating, for the UE, one or more signals in accordance with the communication state information.

Aspect 19: The method of Aspect 18, wherein receiving the communication state information comprises: receiving an indication of a capability of the UE to adaptively switch between multiple communication states based on the relative mechanical displacements, wherein the communication state information indicates the capability.

Aspect 20: The method of any of Aspects 18-19, wherein the communication state information indicates a set of available communication states for respective antenna panels of the multiple antenna panels.

Aspect 21: The method of Aspect 20, wherein the set of available communication states include at least one of: a transmitting state, a receiving state, an inactive state, a half-duplex state, or a full-duplex state.

Aspect 22: The method of any of Aspects 18-21, wherein the communication state information is associated with one or more data parameters for one or more channels.

Aspect 23: The method of any of Aspects 18-22, wherein receiving the communication state information comprises: receiving capability information indicating one or more possible communication states associated with the multiple antenna panels based on the relative mechanical displacements.

Aspect 24: The method of Aspect 23, further comprising: receiving updated communication state information indicating a modification to the one or more possible communication states in association with one or more changes in the relative mechanical displacements.

Aspect 25: The method of any of Aspects 18-24, wherein receiving the communication state information comprises: receiving an indication of one or more communication states to be used by the UE, wherein the one or more communication states are for respective antenna panels of the multiple antenna panels.

Aspect 26: The method of any of Aspects 18-25, further comprising: transmitting assistance information associated with facilitating communication via the multiple antenna panels, wherein the information is associated with the communication state information.

Aspect 27: The method of Aspect 26, wherein the assistance information includes an indication to activate one or more transmission configuration indicator (TCI) states.

Aspect 28: The method of any of Aspects 26-27, wherein the assistance information includes a configuration of one or more reference signals associated with beam configurations for coherent transmission or reception.

Aspect 29: The method of any of Aspects 18-28, further comprising: transmitting an indication of a placement for one or more antenna panels of the multiple antenna panels, wherein the placement is associated with enabling one or more communication states indicated by the communication state information.

Aspect 30: The method of any of Aspects 18-29, further comprising: receiving an indication of a performance level of the UE in at least one of different communication states or different mechanical displacements of the multiple antenna panels, wherein the communication state information is associated with the performance level.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit communication state information for multiple antenna panels of the UE, wherein the multiple antenna panels are mechanically displaceable relative to each other, and wherein the communication state information is based on relative mechanical displacements between the multiple antenna panels; and
communicate, via at least one antenna panel of the multiple antenna panels, one or more signals in accordance with the communication state information.

2. The UE of claim 1, wherein the one or more processors, to cause the UE to transmit the communication state information, are configured to cause the UE to:
transmit an indication of a capability of the UE to adaptively switch between multiple communication states based on the relative mechanical displacements, wherein the communication state information indicates the capability.

3. The UE of claim 1, wherein the communication state information indicates a set of available communication states for respective antenna panels of the multiple antenna panels.

4. The UE of claim 3, wherein the set of available communication states include at least one of:
a transmitting state,
a receiving state,
an inactive state,
a half-duplex state, or
a full-duplex state.

5. The UE of claim 1, wherein the communication state information is associated with one or more data parameters for one or more channels.

6. The UE of claim 1, wherein the one or more processors are further configured to cause the UE to:
measure signal leakage associated with the multiple antenna panels, wherein the communication state information is associated with the signal leakage.

7. The UE of claim 6, wherein the one or more processors are further configured to cause the UE to:
identify, based on the signal leakage, one or more antenna placement configurations for respective communication states from one or more communication states indicated by the communication state information; and
perform, prior to communicating the one or more signals, a mechanical adjustment of the multiple antenna panels in accordance with an antenna placement configuration from the one or more antenna placement configurations, wherein the antenna placement configuration is associated with a communication state from the one or more communication states, and wherein the one or more signals are to be communicated in accordance with the communication state.

8. The UE of claim 1, wherein the one or more processors, to cause the UE to transmit the communication state information, are configured to cause the UE to:
transmit capability information indicating one or more possible communication states associated with the multiple antenna panels based on the relative mechanical displacements.

9. The UE of claim 8, wherein the one or more processors are further configured to cause the UE to:
transmit updated communication state information indicating a modification to the one or more possible communication states in association with one or more changes in the relative mechanical displacements.

10. The UE of claim 1, wherein the one or more processors, to cause the UE to transmit the communication state information, are configured to cause the UE to:
transmit an indication of one or more communication states to be used by the UE, wherein the one or more communication states are for respective antenna panels of the multiple antenna panels.

11. The UE of claim 1, wherein the one or more processors are further configured to cause the UE to:
receive, from a network node, assistance information associated with facilitating communication via the multiple antenna panels, wherein the information is associated with the communication state information.

12. The UE of claim 11, wherein the assistance information includes an indication to activate one or more transmission configuration indicator (TCI) states.

13. The UE of claim 11, wherein the assistance information includes a configuration of one or more reference signals associated with beam configurations for coherent transmission or reception.

14. A method of wireless communication performed by a user equipment (UE), comprising:
transmitting communication state information for multiple antenna panels of the UE, wherein the multiple antenna panels are mechanically displaceable relative to each other, and wherein the communication state information is based on relative mechanical displacements between the multiple antenna panels; and
communicating, via at least one antenna panel of the multiple antenna panels, one or more signals in accordance with the communication state information.

15. The method of claim 14, further comprising:
receiving, from a network node, an indication of a placement for one or more antenna panels of the multiple antenna panels, wherein the placement is associated with enabling one or more communication states indicated by the communication state information.

16. The method of claim 15, further comprising:
performing, in accordance with the placement, a mechanical displacement of the one or more antenna panels.

17. The method of claim 14, further comprising:
evaluating, during a training stage, a performance level of the UE in at least one of different communication states or different mechanical displacements of the multiple antenna panels, wherein the communication state information is associated with the performance level.

18. The method of claim 14, wherein communicating the one or more signals comprises:
transmitting, via a first antenna panel of the multiple antenna panels, a first signal, of the one or more signals, at a first time; and
receiving, via a second antenna panel of the multiple antenna panels, a second signal, of the one or more signals, at a second time that at least partially overlaps with the first time.

19. A non-transitory computer-readable medium storing a set of instructions for wireless communication, the set of instructions comprising:
one or more instructions that, when executed by one or more processors of a user equipment (UE), cause the UE to:
transmit communication state information for multiple antenna panels of the UE, wherein the multiple antenna panels are mechanically displaceable relative to each other, and wherein the communication state information is based on relative mechanical displacements between the multiple antenna panels; and
communicate, via at least one antenna panel of the multiple antenna panels, one or more signals in accordance with the communication state information.

20. The non-transitory computer-readable medium of claim 19, wherein the one or more instructions that cause the UE to transmit the communication state information, cause the UE to:
transmit an indication of a capability of the UE to adaptively switch between multiple communication states based on the relative mechanical displacement, wherein the communication state information indicates the capability.
